(19) United States
(12) Patent Application Publication
(10) Pub. No.: US 2007/0050154 A1
(43) Pub. Date: Mar. 1, 2007

(54) Method and apparatus for measuring the properties of petroleum fuels by distillation

(76) Inventor: Tareq Abduljalil Albahri, Jaber Al-Ali (KW)

Correspondence Address: JEFFREY FURR, 253 N. MAIN STREET, JOHNSTOWN, OH, 43031, US

(21) Appl. No.: 11/216,120

(22) Filed: Sep. 1, 2005

(51) Int. Cl. G06F 19/00

(52) U.S. Cl. 702/22

(57) ABSTRACT

It is a purpose of this invention to accurately measure the properties of petroleum and petroleum fractions from a small volume of sample oil in a short period of time with less cost and energy for the analysis by vaporizing and distilling the respective components contained in the sample to be measured by a distillation apparatus. The components in the sample oil are first separated and vaporized by the distillation apparatus and the boiling point distribution of the respective components is measured. The property estimation means is equipped with a property estimation model for evaluating the property estimate value outputted from the property estimation model. The method is incorporated into standard or otherwise any distillation test apparatus to provide accurate measure of the thermodynamic and transport properties of undefined multicomponent mixtures such as crude oil, petroleum fractions, gas condensates and the like.

### CROSS-REFERENCE TO RELATED APPLICATIONS

Not Applicable

### STATEMENT REGARDING FEDERALLY SPONSORED RESEARCH OR DEVELOPMENT

This invention was made with government support under Research Grant No. EC04/01 awarded by the Research Administration at Kuwait University. The government of the state of Kuwait as represented by Kuwait University has certain rights in the invention.

### REFERENCE TO SEQUENCE LISTING, A TABLE, OR A COMPUTER PROGRAM LISTING APPENDIX

Not Applicable

### BRIEF DESCRIPTION OF THE DRAWINGS

FIG. 1 shows a simplified block diagram of the invention within its environment.

FIG. 2 shows a simplified schematic representation of the MEPP model, using the invention within its environment.

FIG. 3 shows a simulation of a true boiling point (TBP) curve using pure components, using the invention within its environment.

FIG. 4 shows the chemical logic flow chart for developing the MEPP model of the invention within its environment.

FIG. 5 shows a comparison of a petroleum fraction's TBP with that simulated from pure components, using the invention within its environment.

FIG. 6 shows a calculated composition of representative pure components in petroleum naphtha, evaluated in practice of the invention.

FIG. 7 shows parity diagrams of some properties of naphtha (x-axis is property value calculated from generalized correlations, y-axis is property value calculated by MEPP model), evaluated in practice of the invention.

FIG. 8 shows the parity diagram for the net heat of combustion of petroleum naphtha, evaluated in practice of the invention.

FIG. 9 shows ASTM D86 Boiling Point Distribution and the Specific Gravity Volume Blending Index Distribution, evaluated in practice of the invention.

FIG. 10 shows the parity diagram for the specific gravity of 206 petroleum fractions, evaluated in practice of the invention.

FIG. 11 shows the neural network architecture for predicting the specific gravity of petroleum fractions, using the invention within its environment.

FIG. 12 shows the parity diagram for the specific gravity of 206 petroleum fractions, evaluated in practice of the invention using neural network.

FIG. 13 shows the parity diagram for the RVP of 362 petroleum fractions, evaluated in practice of the invention using neural network.

FIG. 14 shows the parity diagram for the RON of 333 petroleum fractions, evaluated in practice of the invention using neural network. Input parameters; (a) Boiling point, (b) Boiling point & RVP, (c) Boiling point & AOS (d) Boiling point & RVP & AOS.

FIG. 15 shows the neural network architecture for predicting the RON of gasoline, using the invention within its environment.

### FIELD OF THE INVENTION

This invention relates to material analysis and, in particular, the measuring method for rapidly predicting the property values of complex hydrocarbon fuels in general and especially the property values of gasoline by distillation, and its equipment. Even more particularly, the invention relates to compensation of boiling point distribution measurements used for the prediction of physical properties of hydrocarbons.

### BACKGROUND OF THE INVENTION

Petroleum products, such as gasoline, are typically formulated as blends, consist of thousands of chemical compounds and it is therefore of interest to be able to identify and quantify such components. These products are thus generally identified and classified based on some of the bulk properties, such as, for example: the range of distillation, density, and the cetane number, viscosity, pour point, API gravity and the like. These data are useful both during production of such fuels at the refinery and during delivery of such fuels to the end-user. In either case, with these data, the producer, for production control purposes, or the consumer, to meet engine requirements or for comparative purposes, can assess the quality or value of the product at hand. It is therefore of great interest to be able to ascertain, with specificity, the properties of hydrocarbon-based fuels.

Many characterizing properties or attributes such as Reid vapor pressure, viscosity, refractive index, and hydrogen to carbon (H/C) content, paraffin, naphthene and aromatic (PNA) content, aniline point, octane number, freezing point, cloud point, smoke point, diesel index, refractive index, cetane index, etc. are generally measured for a crude oil or certain of its fractions according to well specified ASTM tests.

Detailed characterization of petroleum fuels entails using sophisticate analytical equipment such as GC and NMR. Conceptually it is possible to obtain detailed molecular and structural composition of petroleum fractions using GC-MS and NMR techniques in the order of few days. However, these extensive experimental programs can be complex, expensive and time consuming and thus undermine the motivation for analyzing each feedstock. Hence these analytical methods did not find wide acceptance in daily refinery operation.

Recognizing that molecule-by-molecule measurements in petroleum feed-stocks would be difficult, we sought to define and characterize the naphtha feedstocks in a simple mathematical way that would allow for a property representation of a given feedstock. Since the ASTM D86 distillation test has found wide acceptance in refinery daily operation on a routine basis we sought utilizing these traditional definitions of complex petroleum feedstocks for achieving that objective.

Accurate characterization of petroleum fuels is an important step in the application of kinetic and thermodynamic calculations for the design, operation, and simulation of petroleum refining processes. An insufficient description of heavier hydrocarbons (e.g. pentane and heavier; C₅⁺) reduces the accuracy of predictions. Unfortunately, complete experimental data on the C₅₊ hydrocarbon fraction are seldom available. Ideally, fuels properties are determined experimentally in the laboratory on actual fluid samples taken from the process under study. Because of the expense of the experimental determination of such data, there is interest in their accurate prediction.

In order to speed up the execution of real-time simulation, a series of simplified correlations has been proposed for the evaluation of physical properties of petroleum fractions during the last five decades [1]. Several charts and correlations were developed many of which require as input parameters the fuels global properties such as the average boiling point, the specific gravity and some characterization factors and are therefore not suitable for incorporation into the new generation of molecularly-explicit simulation models. In addition, wide boiling range fractions are mixtures of a large number of hydrocarbon compounds the type of which varies along the distillation curve, therefore a single value for boiling point or specific gravity does not characterize the fraction very well. Moreover, as many existing correlations are based on properties of pure compounds, errors in predicted values from the correlations increase significantly when the methods are applied to mixtures.

Distillation curve provides a breadth of information about the crude oil or the petroleum fuel. In certain respect the boiling point distribution is representative to the composition of the petroleum fraction. Therefore, in principle, by determining the presence and volume percent of the components in a conventional hydrocarbon fuel solution, the overall physical properties can be determined.

There are many types of standard distillation tests that determine the boiling point distribution of petroleum fuels the inter-conversion between which is described in the literature. Some of the more common standard test methods for distillation of petroleum products are,

(1) ASTM D86-96 which is curried under atmospheric pressure and is used for determining the boiling point distribution of light petroleum fractions such as naphtha, kerosene, diesel, and light gasoil.

(2) Micro distillation.

(3) Molecular distillation.

(4) Fractional distillation ( Spinning Band Still).

(5) ASTM D5236 distillation (Pot Still).

(6) D1160 (Heavy petroleum fractions (heavy and vacuum GO, atm residue, vac residue).

(7) ASTM D3710 Simulated Distillation which is also known as GC SimDist method uses gas chromatography (GC) method determines the TBP of gasoline.

(8) ASTM D2887 Simulated Distillation which is also known as SimDist method uses Gas Chromatograph (GC) method determines the TBP of petroleum fraction other than gasoline.

(9) ASTM D2892 also known as 15/5 distillation produces simulated TBP of petroleum fuels using a distillation column with 15 theoretical plates and a reflux ratio of 5.

(10) ASTM D5236 Distillation which is also known as Vacuum Potstill Method is used for heavy hydrocarbon mixtures.

(11) ASTM D5307 Simulated Distillation (GC method); determines the TBP of crude oil.

(12) ASTM D6352-98 Simulated Distillation (GC method); Replaces ASTM D2887 method.

(13) Hemple analysis for the distillation for a large volume of fuel sample for further detailed analysis of the produced distilled cuts.

Tests 1 & 6 may be combined together for determining the boiling point distribution of wide boiling range materials such as crude oils.

In a distillation device operated according to the ASTM D86 standard test method, for example, a 100 ml petroleum sample, placed in a flask, is heated in a regulated rate, so that a uniform average rate of condensation in ml/min is maintained. This rate varied from zero to 5 volume % recovered, from 5 to 10 volume % recovered and so on. When the first drop appears at the lower end of the condenser tube, the thermometer reading (vapor temperature) is recorded as the initial boiling point (IBP). Temperature readings are recorded at several volume % distilled (Table 1) up to the final boiling point (FBP) and heating is discontinued. After the flask has cooled the volume of remaining liquid is measured and recorded as the recovery. For heavy fractions, heating is discontinued when decomposition point is observed; the vapor reaches a maximum temperature then starts declining before the end point. The volume increments for the reported boiling point distribution by the ASTM distillation apparatus is user selected and Table 1 is but one such example.

TABLE 1
Data output from ASTM D86 distillation test

| Vol % | T (° F.) |
|---|---|
| 0 | IBP |
| 10 | T_{10%} |
| 30 | T_{30%} |
| 50 | T_{50%} |
| 70 | T_{70%} |
| 90 | T_{90%} |
| 100 | FBP |
| Recovery | ≈98% |

Traditionally, the analytical methods that relate to determining petroleum properties in hydrocarbons take a long time to carry out and are thus very time-consuming. In the laboratory, the properties are measured using numerous analytical and physical test equipments with skilled personnel to conduct. For each experimentally determined property there is at least one apparatus, thus for 30 properties there is need for 30 apparatus. These equipments are expensive, require frequent maintenance and the availability of many samples of the fuel, and take about several minutes to hours per sample to run thus raising the cost of energy and manpower.

It is thus apparent that there is a need in the art for an improved method of measuring the properties of a hydrocarbon. The present invention meets these and other needs. Furthermore, there is need for rapid, accurate, and cost effective yet readily available measurement of the physical properties of hydrocarbons.

### PRIOR ART REFERENCE

Various indirect methods are known for the evaluation of fuel properties indirectly. Conventional gas and liquid chromatography (GLC), infrared and mass spectroscopy (IR), Nuclear magnetic resonance (NMR), hydrogen ion nuclear magnetic resonance (HNMR), nitrogen nuclear magnetic resonance (NNMR), and Fourier Transform Infrared Spectroscopy (FTIR) techniques and the like enable sampling and evaluation of a fuel's components but the equipment is both expensive and ordinarily not available for evaluation of a delivered product. They are seldom used in refinery daily operation while distillation on the other hand is routinely used on daily basis. It would therefore be highly desirable to have a method for rapidly predicting properties of crude oils and/or their boiling fractions using a single apparatus, and preferably an apparatus that is widely used in the refining industry such as the ASTM D86 or D1160 distillation apparatus for example.

Gas chromatography has been used to predict petroleum properties in gasoline-type petroleum products through indirect measurements. Crawford and Hellmuth, Fuel, 1990, 69, 443-447, describe a chromatographic analysis that is able to predict the octane numbers of various effluents that come from the refinery, by application of mathematical models that are based on the statistical technique of principal component regression (PCR).

Japan Patent no. JP3100463 (1991) to TAKAMURA et al. discloses a method and instrument for measuring cetane value or cetane index in a sample from an extremely small volume of sample oil in a short period of time by separating and eluting the respective components contained in the sample to be measured by using gas chromatograph coupled to mass spectrometer. The cetane value or cetane index is determined by substituting the variables with the regression formula in which parameters are previously determined.

Japan Patent no. JP9318613 (1997) to SASANO discloses a measuring method of research octane number of gasoline by gas chromatograph and its apparatus, by separating components of a gasoline sample with a gas chromatograph using a specific column, and by substituting a specific equation with a physical property of a component which is selected by being only identified on a peak area value equal to or more than a predetermined value.

U.S. Pat. No. 5,699,269 (1997) to Ashe, et al. discloses a method for predicting chemical or physical properties of crude oils or their boiling fractions which comprises GC/MS analysis wherein the often collinear data generated is treated by multivariate correlation methods.

U.S. Pat. No.6,275,775 (2001) to Baco, et al. discloses a method for determining at least one physico-chemical property of a petroleum fraction by gas chromatography coupled with an atomic emission detector (GC-AED) to determine the distribution of an element from the group of carbon, hydrogen, sulfur, and nitrogen, as a function of the boiling points of the components of the sample, and the coefficients of the correlative model are determined from all of the data. The petroleum fraction whose property is to be determined is analyzed by chromatography under the same conditions, and the data that are obtained are multiplied by the coefficients of the model to determine the value of said property as a function of the boiling points of its components. Application to the determination of the cetane number as a function of the distillation profile of the components of the petroleum fraction.

Near infrared spectrometric analysis has been used to determine indirectly the qualitative properties of various hydrocarbon samples. Examples are; “Prediction of Gasoline Octane Number from Near Infrared Spectral Features in the Range 660-1215 nm” by Jeffery J. Kelley, et al., Analytical Chemistry, Volume 61, Number 4, Feb. 15, 1989, pp. 31320, and “Predicting Gasoline Properties Using Near-IR spectroscopy” by Stephen J. Swarin and Charlene A. Drumm, Spectroscopy, Volume 7, number 7, September 1992, both describe a method of predicting the antiknock index of gasoline using near infrared spectrometry. These methods described passing energy in the near infrared region of the electromagnetic spectrum through a sample of gasoline and measuring the wavelength of radiation absorbed by the gasoline and the amount of absorption at each wavelength. This measurement results in a spectral profile, or spectrum, which can then be compared to the spectrum of a data set of samples having known antiknock indexes.

U.S. Pat. No. 4,800,279 (1989) to Hieftje, et al. discloses methods and devices for near-infrared evaluation of physical properties of samples. Methods are disclosed for quantifying physical properties of gaseous, liquid or solid samples.

One method of evaluating fuel properties is known as near-IR spectroscopy, in which a sample is excited with light from a near-IR light source. Since known fuel components exhibit characteristic vibrational mode overtones when excited in the near-IR, the vibrations of unknown constituents can be evaluated and classified accordingly. The typical evaluative process is complex, involving substantial non-linear data comparisons. Kelly, et al, describe such a method in “Prediction of Gasoline Octane Numbers from Near-Infrared Spectral Features in the Range 660-1215 nm,” Vol. 61, Analytical Chemistry, No. 4, p.313, Feb. 15, 1989, in which vibrational overtones and combination bands of CH groups of methyl, methylene, aromatic, and olefinic functions were observed in the near-IR spectral region. With the aid of multivariate statistical analysis, the spectral features were correlated to various fuel quality parameters, including octane number. The property or yield is usually determined by applying a correlation between the property or yield and the absorbance values. The correlation is determined experimentally by multivariate regression or neural network and is dependent upon the type of spectrometer employed, the property or yield to be determined, and the frequencies used.

U.S. Pat. No. 4,963,745 (1990) to Maggard discloses an octane measuring process and device comprising the near infrared absorbance of the methyne band measures octane (pump, RON, and MON) with excellent correlation and can be used for gasoline blending. This patent is an example of near infrared absorbance evaluation between 1200 and 1236 nm applied to the methyne band along with the tertiary butyl band, indicative of sources of free radicals which seem to lead to smooth combustion. The signal processing techniques used, however, are complex, including first, second, third, and fourth or higher derivative processing as well as various known curve fitting techniques.

U.S. Pat. No. 5,362,965 (1994) to Maggard discloses an indirect method for determining oxygenate content and/or octane of hydrocarbon fuels using near-infrared absorption spectra selecting nanometer frequencies in the range 1,300 to 1,350 to reduces the temperature dependence of calibration equations that predict values representative of both oxygenate content and octane.

U.S. Pat. Nos.5,349,188 and 5,349,189 both issued (1994) to Maggard discloses a process and apparatus for analysis of hydrocarbons by near-infrared spectroscopy to measure the weight percent, volume percent, or even mole percent of each component, e.g. PIANO (paraffin, isoparaffin, aromatic, napthenes, and olefins), octane (preferably research, motor or pump), and percent of various hydrocarbons, e.g. alpha olefins.

U.S. Pat. No. 5,145,785 (1992) to Maggard et al. discloses determination of aromatics in hydrocarbons by near infrared spectroscopy of mid-distillate hydrocarbon fuels. Preferred NIR bands of 1650-1700 and 2120-2256 exhibit excellent correlation with aromatics content.

U.S. Pat. No. 5,121,337 (1992) to Brown discloses a method for correcting spectral data for data due to the spectral measurement process itself and estimating unknown property and/or composition data of a sample using such method. The correction method is preferably included in a method of estimating unknown property and/or composition data of a sample under consideration.

U.S. Pat. No. 5,446,681 (1995) to Gethner, et al. discloses a method of estimating property and/or composition data of a test sample. A method of operating a spectrometer to determine property and/or composition data of a sample comprises an on-line spectral measurement of the sample using a computer controlled spectrometer, statistical analysis of the sample data based upon a statistical model using sample calibration data, and automatically identifying a sample if necessary based upon statistical and expert system (rule-based) criteria.

U.S. Pat. No. 5,424,959 (1995) to Reyes, et al. discloses a method for interpretation of fluorescence fingerprints of crude oils and other hydrocarbon mixtures using neural networks. The artificial intelligence system is used with a conglomeration of fluorescence data to provide a method of improving recognition of an unknown from its spectral pattern.

U.S. Pat. No. 5,218,529 (1993) to Meyer, et al. discloses a neural network system and methods for analysis of organic materials and structures using spectral data. Characteristic spectra are obtained for the materials via spectroscopy techniques including nuclear magnetic resonance spectroscopy, infrared absorption analysis, x-ray analysis, mass spectroscopy and gas chromatography.

Japan Patent no. JP9243634 (1997) to Sato and Fujimoto discloses an apparatus for estimating properties of petroleum product. The property estimation means is equipped with a property estimation model using a neutral network and a property analyzed value obtained by analyzing the petroleum product. In the property estimation model, properties can be calculated from operation data within a real time.

U.S. Pat. No. 5,452,232 (1995) to Espinosa, et al. discloses a method and apparatus for determining a property or yield of a hydrocarbon product based on Near Infra-Red (NIR) spectrum of the feedstock.

U.S. Pat. No. 5,360,972 (1994) to DiFoggio, et al. discloses a method for improving chemometric estimations of the physical properties of materials. The present invention is a method for improving the estimation of physical properties of a material, based on the near- and mid-infrared spectrum of the material. The method further discloses use of a combination of Raman spectroscopy, gas chromatography, and mid-infrared spectroscopy for the same purpose of the invention.

U.S. Pat. No. 5,225,679 (1993) to Clarke, et al. discloses methods and apparatus for determining hydrocarbon fuel properties. Detection is made of absorption related to signature vibrational modes associated with the fuel component molecules when excited in the mid-IR. From the determined fuel component quantity and known characteristics, the fuel solution properties are predicted. In one embodiment, octane rating and vapor pressure for a fuel solution is determined in-situ and in real time.

U.S. Pat. No. 5,412,581 (1995) to Tackett discloses method for measuring physical properties of hydrocarbons using near infrared spectrum measurement.

In all above patents the property value for the petroleum hydrocarbon mixture was calculated using a mathematical correlation or neural network the input parameters of which are either the GC-measured pure component concentrations or the spectral parameters. If a property like octane number for example can be estimated by fitting GC and IR characteristic output data then the same can be done for all thermo-physical properties as well using the characteristic output data from distillation.

All the above patents disclose using either infrared or gas chromatography for the purpose of predicting one or more of the properties of petroleum or its fractions. None of the above patents claims or discloses using distillation temperatures for that purpose. The method of the present invention meets the novelty requirement.

### SUMMARY OF THE INVENTION

This invention relates to a method for predicting physical, performance, perceptual and/or chemical properties of a crude oil or one of it boiling fractions. The analytical method that is able to predict a set of data that consist of global petroleum properties of petroleum products, from correlative mathematical models which will be determined, according to conventional analytical methods.

It is a purpose of this invention to calculate the properties of a petroleum product with high reliability. The method of the invention comprises a property estimation apparatus has a property estimation means estimating the properties of a petroleum product from the apparatus to output a property estimate value. The property estimation means is equipped with a property estimation model for evaluating the property estimate value outputted from the property estimation model and a property analyzed value obtained by analyzing the petroleum product. The property estimation model may comprise at least an optimization algorithm, a neural network algorithm, a regression algorithm, or genetic algorithm, or the like.

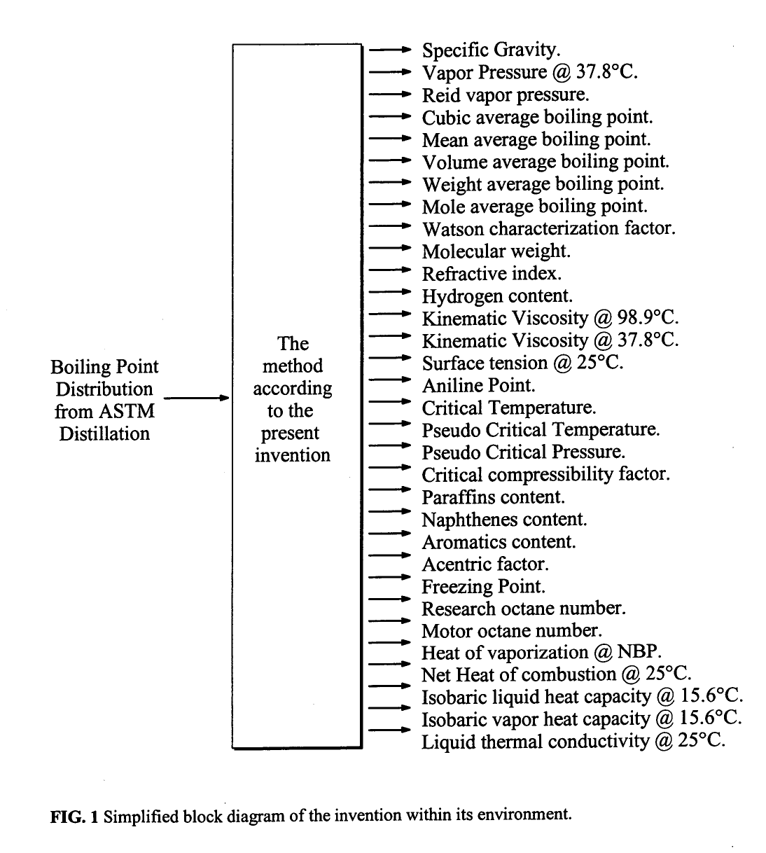

In this invention a mathematical algorithm is used with a conglomeration of distillation data to provide a method of improving recognition of an unknown from its boiling point distribution pattern as shown in FIG. 1. Customized mathematical algorithms allow the ultimate organization and resourceful use of assumption-free variables already existing in distillation apparatus for a much more comprehensive, discrete and accurate differentiation and matching of thermo-physical and transport properties than is possible with human memory. The invention provides increased speed of fingerprinting analysis, accuracy and reliability together with a decreased time, cost and energy for the analysis.

The present invention is based on a recognition that the molecules of components of a hydrocarbon solution each exhibit physical and chemical characteristics that such signatures are exhibited in terms of the boiling point, and that such physical and chemical characteristics can be correlated either linearly or nonlinearly with volume, mass, or volume percent of the associated component in solution. Where the properties of the components are known, such as octane, vapor pressure, and the like, the volume, mass, or mole percent quantification of these components can be used in practice of the invention to characterize the total property of hydrocarbon solution. Therefore, in one aspect of the invention, molecules of fuel components in a hydrocarbon fuel solution are vaporized and their boiling point is detected and used to identify the presence of and to quantify the volume, mass, or mole percent of the fuel components in solution. From this data, and knowledge of the known properties of the fuel components, the properties of the fuel solution are determined by computation.

Accordingly, in one embodiment of the invention, a known volume of a petroleum sample, placed in a vessel, is heated in a regulated rate which is varied from zero to 100 volume % recovered (or so). When the first drop appears at the lower end of the condenser tube, the thermometer reading (vapor temperature) is recorded as the initial boiling point (IBP). Temperature readings are recorded at several volume % distilled up to the final boiling point (FBP) where heating is discontinued and the volume of remaining liquid is measured and recorded as the recovery. The boiling point distribution is indicative of the type and amount of the fuels components determined to be characteristic of the fuel component of interest.

In a preferred embodiment the boiling point distribution data from the distillation apparatus is processed in a processing section of the device, in which the data is linearly or nonlinearly correlated to volume percent of the fuel component in solution. In one embodiment the fuel components in solution may be real components. In another embodiment the fuel components may be pseudocomponents defined as either boiling point or volume percent cuts.

In another preferred embodiment the boiling point distribution data is correlated to volume percent of the fuel component in solution using optimization algorithms. In another preferred embodiment the boiling point distribution data is correlated to volume percent of the fuel component in solution using simple regression techniques. Yet in another preferred embodiment the boiling point distribution data is correlated to volume percent of the fuel component in solution using neural networks.

In another embodiment the boiling point distribution data from the distillation apparatus is processed in a processing section out of the device. In a preferred embodiment, the boiling point distribution data is used to compute the composition and the properties of the petroleum sample in the processing section within the distillation apparatus, and a display output is then generated accordingly. Likewise, other components and properties may be found and quantified in a similar manner. Where a plurality of components are of interest, a plurality of distillation apparatus and associated boiling point distribution detectors are employed, respectively, and the plurality of detection data is processed and then combined in an additive process to obtain total properties for the fuel.

In one embodiment, a molecularly-explicit property prediction (MEPP) model developed according to the method of the present invention is tested using a molecular ensemble comprising 68 molecules to characterize and predict the properties for 30 different petroleum naphtha samples and is shown to be in excellent agreement with the current conventional prediction methods based on global properties. In another embodiment a pseudocomponent property prediction model developed according to the method of the present invention is tested to measure the density of petroleum fractions using 100, 5, and 1 pseudocomponent cuts and is shown to be in excellent agreement with experimental data. Yet in another embodiment artificial neural networks are used to predict the specific gravity (SG), Reid vapor pressure (RVP), and research octane number (RON), and are shown to be in excellent agreement with experimental data.

The distillation method described above can be used to predict a wide range of chemical and physical properties (including performance and perceptual properties) of petroleum fuels such as, molecular weight, true vapor pressure, the specific (API) gravity, various types of boiling point averages, Watson characterization factor (K_{w}), refractive index, carbon to hydrogen content, kinematic viscosity, the surface tension of liquid, aniline point, cloud point, true critical temperature, pseudocritical temperature, true critical pressure, pseudocritical pressure, critical compressibility factor, acentric factor, flash point, freezing point, heat of vaporization at the normal boiling point, net heat of combustion, isobaric liquid heat capacity, isobaric vapor heat capacity, liquid thermal conductivity, research and motor octane numbers, and the like, within the distillation apparatus in a short time period and using one test.

Because of such simplicity, the invention enables fuel properties to be easily determined and displayed. Such fuel properties may include octane rating equivalent to the ASTM rating, molecular weight, and various other properties of the components of interest. In fact, while the ASTM methods of obtaining the physico-chemical properties are labor-intensive laboratory procedures, the present invention provides an equivalent property measurement in-situ and in real-time. The invention provides increased speed of fingerprinting analysis, accuracy and reliability together with a decreased learning curve and heightened objectivity for the analysis.

Such apparatus and processes are particularly useful for recognizing and identifying organic compounds such as complex hydrocarbons, whose analysis conventionally require a high level of training and many hours of hard work to identify, and are frequently indistinguishable from one another by human interpretation. The present invention is therefore a valuable addition to the art of fuels properties detection.

Upon further study of the specification and appended claims, further objects and advantages of this invention will become apparent to those skilled in the art.

The above and other aspects, features, and advantages of the invention will be better and more fully understood by reference to the following detailed and more particular description of the invention, presented in conjunction with the following drawings, wherein:

### DETAILED DESCRIPTION OF THE INVENTION

It is therefore an object of the present invention to provide a simple method and apparatus for fuel property detection.

It is another object of the present invention to provide a relatively inexpensive, real-time, in-situ detection method and apparatus for detection of the properties of a hydrocarbon solution.

It is still another object of the present invention to provide a simplified method and apparatus for obtaining boiling point distribution data relating to the components in a fuel solution and from which predicting fuel properties without complex analytical processing techniques.

It is further an object of the present invention to present a method for predicting various properties of a C₅⁺ petroleum fraction based on the knowledge of the mixture's global properties that are easily measurable in the laboratory such as ASTM D86 distillation for example.

Another object of the present invention is to provide a method to predict the various properties of a C₅⁺ petroleum fraction based on the knowledge of the mixture's boiling point distribution using ASTM D86 distillation.

Yet, it is further an object of the present invention to is to provide a method to predict the various properties of a C₅⁺ petroleum fraction based on the knowledge of the mixture's boiling point distribution using ASTM D86 distillation which can be incorporated into the ASTM distillation apparatus to predict the various properties of the distilled petroleum fraction using one single laboratory test and apparatus.

It is further an object of the present invention to provide a property prediction model that complements the new generation of molecularly-explicit models for simulating the kinetics and dynamics of petroleum refining processes.

Yet it is further an object of the present invention to provide a property prediction model that has the flexibility to be tailored to use any set of pure components as desired to suit specific needs.

It is further an object of the present invention to provide a model that is powerful for simulating and predicting the properties of petroleum fuels.

It is further an object of the present invention to provide a procedure for predicting the fluid properties that is simple and straightforward.

It is further an object of the present invention to provide a model that requires limited information from readily available lab analysis and simple analytical characterizations to describe a petroleum feedstock.

It is further an object of the present invention to provide a method for predicting the global properties of molecular ensembles produced during various physical and chemical processing scenarios as they progresses, a feature that is currently lacking in contemporary simulation packages used in the refining industry such as HYSYS, ASPEN, and PROVISION which cannot determine the global properties of a processed petroleum fraction after it has been divided into pseudocomponents.

It is further an object of the present invention to provide a computerized procedure that can be combined with or incorporated in said simulation packages thus enhancing their information content and predictive ability.

It is further an object of the present invention to present a model that provides a foundation for developing molecular-based property relationships and incorporates well-established correlations to estimate mixture properties, which is an essential need of future process models; the capability of predicting physical and performance properties of undefined multicomponent hydrocarbon mixtures.

It is further an object of the present invention to provide a model with an ability to complement the molecularly-explicit kinetic models of petroleum refining processing making use of the vast information available in the literature on pure components.

It is further an object of the present invention to provide a to develop a model for predicting the properties of undefined multicomponent mixtures and light petroleum fractions using a characterization method that is more suitable for incorporation in the molecularly-explicit simulation models than the current methods and to enhance the prediction performance of chemical process simulation packages.

It is further an object of the present invention to provide a model with flexibility where the number and type of model components in the molecular ensemble may be tailored as needed by the user to accommodate specific simulation needs.

It is further an object of the present invention to provide a computerized procedure that can be incorporated as software in the ASTM D86 distillation apparatus hardware to provide estimation of the properties of petroleum fractions using one single laboratory test.

It is further an object of the present invention to provide a method and apparatus that will lead to large savings in terms of energy, time and cost whereby one distillation test can replace the test equipment needed to predict all of the properties of a petroleum fuel.

It is further an object of the present invention to provide a method that combines routine analytical tests and a molecularly-explicit modeling approach to provide quantitative insight to the petroleum fractions structure which permits easy accounting of molecules and enabled the direct estimation of the thermodynamic and transport properties thereof.

It is further an object of the present invention to provide a method that can calculate the properties of light petroleum fractions with good accuracy when at least one bulk property (e.g. ASTM D86 or TBP distillation temperatures) is available.

It is further an object of the present invention to provide a method that is applicable to any petroleum fraction.

It is further an object of the present invention to provide a method that can model the complex nature of petroleum fuels by a limited set of representative molecules considering the difficulty and complexity of accounting for the thousands of compounds in petroleum fuels and can be an effective alternative to the conventional pseudocomponent technique.

It is further an object of the present invention to provide a method that is useful in representing a broad range of different petroleum feedstocks provided relatively simple set of experiments are performed to characterize the attributes of the feed.

It is further an object of the present invention to provide a molecularly-explicit simulation model of feedstock structure and properties that can be a direct input for molecular reaction models which can ultimately be used to map out the changing molecular population with respect to various processing conditions.

It is further an object of the present invention to provide a method that can be of benefit for the future modeling of the various aspects of petroleum refinery processes which require detailed knowledge of both the molecular composition and structure of the petroleum fraction feeds, intermediates and products for the proper modeling of the physical separations and chemical reactions of refinery units.

It is further an object of the present invention to provide a method for petroleum feed characterization that can be used to simulate gasoline production processes include Catalytic Reforming, Alkylation, Isomerization, and (Fischer-Tropsch) gasoline synthesis as well as the blending of the feeds and products of these processes for gasoline production, that can be used to increase octane number, improve efficiency, and reduce cost and pollution.

### DESCRIPTION OF PREFERRED EMBODIMENTS

The above and other aspects, features, and advantages of the present invention will be better and more fully understood by reference to the following detailed and more particular description of the invention, presented in conjunction with the following examples which are provided to further define the invention and are in no way meant to limit the scope of the invention to the particulars of these examples, wherein:

### EXAMPLE 1

### A Molecularly-Explicit Characterization and Property Prediction Method

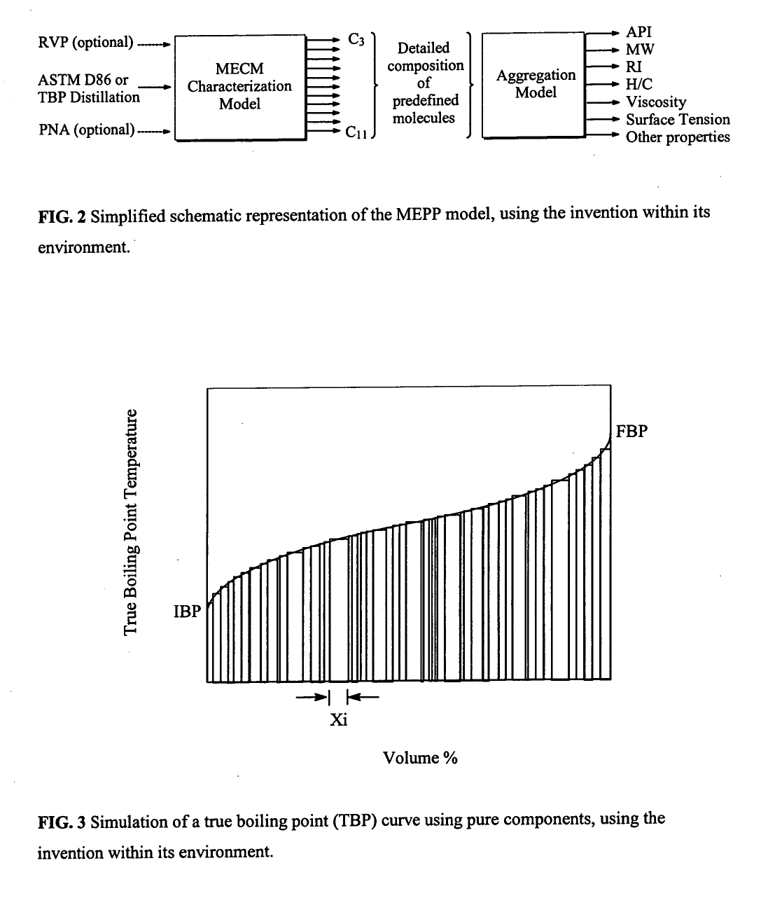

In one embodiment, the property prediction model is based on the concept that the global properties of a petroleum fraction such as the TBP distribution, vapor pressure, PNA fractional composition must be equal to those calculated from the pure components comprising that petroleum fraction. When some bulk and pure component properties are available, the composition of a limited set of pure components in the petroleum fraction may be predicted using optimization algorithms as simplified in FIG. 2. The predicted composition may then be used to predict the other global properties of the petroleum fuel using appropriate mixing rules.

The standard input global-properties for the model are the petroleum fractions distillation data (either ASTM D86, TBP, SimDist, etc), the RVP, and the PNA content. The internally calculated global properties are the molecular weight, the true vapor pressure at 37.8° C., the specific (API) gravity, the cubic average boiling point (CABP), the mean average boiling point (MeABP), the volumetric average boiling point (VABP), the weight average boiling point (WABP), the molar average boiling point (MABP), the Watson characterization factor (K_{w}), the refractive index, the carbon to hydrogen content, the kinematic viscosity at 37.8 and 98.9° C., the surface tension of liquid at 25° C., the aniline point, the cloud point, the true and pseudocritical temperatures and pressures, the critical compressibility factor, the acentric factor, the flash point, the freezing point, the heat of vaporization at the normal boiling point, the net heat of combustion at 25° C., the isobaric liquid and vapor heat capacities at 15.6° C., the liquid thermal conductivity at 25° C., and the research and motor octane numbers. The internally calculated global properties of the petroleum fraction are determined using well established methods in the literature or from methods developed specifically for this purpose [2].

The above analytical input (distillation data, RVP, and PNA content) and the computationally predicted internal properties are also calculated from pure components data. The two methods are contrasted and the difference is minimized using an optimization algorithm. The model output is a computationally generated explicit atomic detail of the petroleum feedstock. This outcome molecular ensemble retains the qualitative features that mimic light petroleum fractions in terms of thermodynamic and transport properties.

Experimental values of the RVP and PNA content are always desirable. However, if not supplied as input, they are calculated making the ASTM D86 distillation or the true boiling point (TBP) the only experimental data required as input. The availability of other input properties such as for example the API gravity is an additional benefit to improve the model predictions but is not essential.

In our work on the simulation of light petroleum fractions we developed the MECM model that can determine the optimum molecular distribution in petroleum fractions [2,3]. The concentration of a pre-selected set of representative true-components is calculated using the global as well as the internal and structural properties of the petroleum fraction. We have observed that it not essential for all the properties of the petroleum fuel to be optimized against those from the pure components. In fact only the ASTM D86 Distillation, the PNA content and the RVP were sufficient to provide a feasible solution. All the other properties calculated form the bulk properties of the petroleum fraction and those from the pure components within were almost identical. This lead us to believe that the properties of a petroleum fraction can be estimated from the above three properties alone. Since generalized correlations are available in the literature for PNA fractional composition and RVP, complete characterization can be obtained from the knowledge of only the ASTM D86 distillation data. Here we enhance the MECM model with property prediction capabilities and provide a new molecularly-explicit property prediction (MEPP) model that can be used to predict the properties of light petroleum fractions using ASTM D86 distillation data alone.

### MEPP Model Details

The average (global) physical property of the petroleum fraction, Θ, can be calculated by integration of the pure component properties along the true boiling point curve according to the following relation (Riazi, M. R.& Daubert, T. E. Ind. Eng. Chem. Res. 1987, 26, 629-632),

$$Θ = {\int }_{0}^{1} Θ ( x ) ⅆ x \qquad ( 1 )$$

where x is the fraction of volume vaporized in a TBP distillation, and Θ(x) is the property value at x.

For a finite number of increments (components), the solution of the integral term in the above equation may be attained by calculating the area under the property distribution curve and Equation 1 may be approximated by the following expression representing that area,

$$Θ = {\sum }_{i = 1}^{n} {Θ}_{i} ( x ) Δ {x}_{i} \qquad ( 2 )$$

where n is the number of increments (or pure components in the molecular ensemble), Δx is the increment size (i.e. volume fraction of the pure components), Θᵢ(x) is the property value or a function thereof for the increment Δxᵢ (or the pure component).

Since some pure component properties do not mix linearly, mixing rules may be applied to estimate the properties of the defined mixture. Therefore, in principle it is possible to use the above relation to predict the composition of the pure components, x, from the knowledge of the physical properties of these components and those of the mixture.

In the MECM model, a petroleum fraction is divided into a number of increments along the true boiling point (TBP) curve as shown in FIG. 3. This is equal to the number of pre-selected representative true compounds for which the concentration is to be determined. Since the number of components used in the model is finite, the above equation need not be integrated and instead mixing rules may be applied. For example, to relate the API of a petroleum cut to that of the pure components in it, the specific gravity (SG) at 15.6° C. is used (since API does not mix linearly) and the above property relation may be written as follows,

$$SG = {\int }_{0}^{1} SG ( x ) ⅆ x \qquad ( 3 )$$

For a finite number of components (n), this relation may be reduced to the following form,

$$SG = {\sum }_{i = 1}^{n} {( SG )}_{i} {( {x}_{w} )}_{i} \qquad ( 4 )$$

where (x_{w})ᵢ is the mass fraction of the true-component i in the petroleum cut. Similar relations may be produced for other properties which may be solved for x (pure component concentrations) using an optimization algorithm.

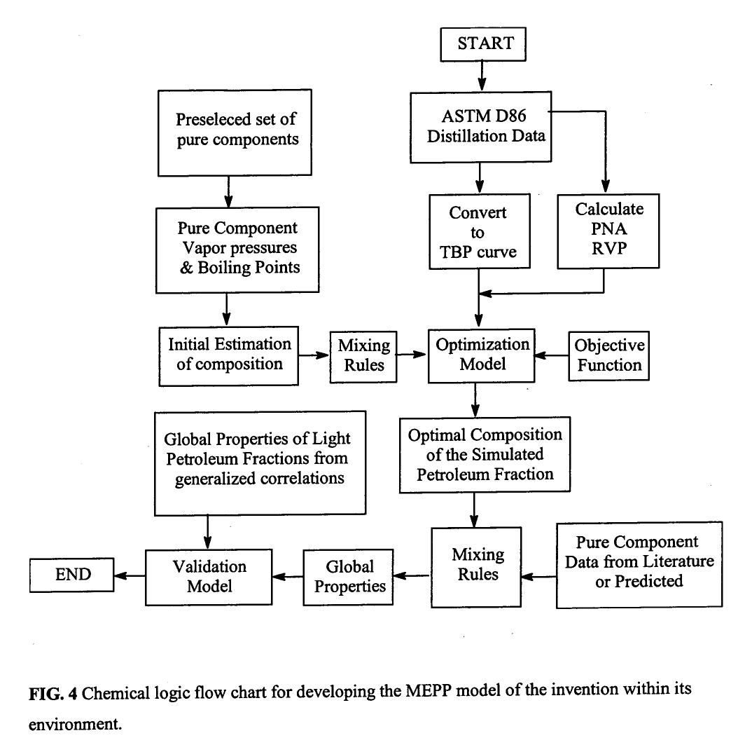

The theoretical background of the MECM model is presented in detail in Albahri [2] the teachings of which are incorporated herein by reference. The MECM was taken one step further by incorporating it in the MEPP model to make it viable for property prediction purposes [4]. The chemical logic diagram for this system is depicted in FIG. 4 which illustrates the methodology used to develop the MEPP model and the procedure followed to analyze the simulation problem.

The first step in this scheme consists of information gathering about a particular light petroleum fraction (for example naphtha) from existing plants or the literature. In order to characterize the unknown hydrocarbon mixture laboratory analysis are used to determine the API gravity, RVP, PNA content and TBP. These experimental procedures provide the input to the molecular feedstock simulation. Out of these four properties the TBP must be available, which is usually the case, while the other properties, if not available, may be estimated. The other global properties of the petroleum fraction are calculated internally by the MECM model using well established methods in the literature [2].

The second step in this scheme comprises using a molecular ensemble comprising 68 molecular species as an example to simulate petroleum naphtha as shown in Table 2. The basis for the selection of the pure components is discussed in details by Albahri [2, 3] the teaching of which is incorporated herein by reference. The second step in this scheme also comprises collecting the pure component properties from the property databanks of the API-TDB [1], AIChE-DIPPR [5], PGL [6] and others [7]. In the absence of a certain property value for a molecule, common correlations for various physical properties, available in literature [6] are used to estimate it. Estimation methods were also developed specifically for this purpose when reliable correlations were not available [8, 9, 10, 11].

The computational description of the complex feedstock addressed the challenge of providing a unique identity to each of the ensemble molecules. The computational identification of each unique component is crucial not only to the description of complex feedstocks, but is also necessary for the development of molecular reaction models and the prediction of product properties.

An important challenge in modeling the refinery processes is the development of a reliable yet practical molecularly-explicit characterization model for complex feed-stocks where the number of components is not too excessive for computation power (during kinetic modeling and rigorous phase equilibrium calculations) or too diminutive for modeling purposes. The catalytic cracking of n-heptane alone for example is reported to undergo 2210 reactions and 336 intermediates [12]. When the feed is a complex mixture, like Naphtha or gas oil containing thousands of hydrocarbons, the number of components in the reaction mixture becomes enormous and the generation of reaction networks for each of the feed components becomes an overwhelming task. For that reason, predicting molecular compositions of 10⁴ molecules in petroleum and its fractions [3] is impractical for use in kinetic modeling. It also does not account for all the inherent molecular species from which 1500 have been so far identified in gasoline alone [14]. Molecule-by-molecule separation and identification is a worthy goal that is nevertheless beyond present capabilities for naphtha not to mention resides, asphaltenes and even very heavy oils.

For that reason, the presented model will not account for the 10,000 plus components of petroleum fractions as that is impractical for our modeling needs, or indeed, the computational capabilities available today. Rather, it will account for a limited set of pure components that will be capable of representing the whole petroleum fraction. The set chosen here (as an example to simulate naphtha) comprises 68 model-compounds chosen in such a way as to account for the overall components that exist in the fraction. This reduced the number of parameters and resulted in large CPU savings.

The final number of model components was arrived at by screening over 200 pure components based on our background knowledge of structural chemistry and relative volatility in addition to other criteria available in literature as presented in details in Albahri [2] the teachings of which are incorporated herein by reference. In that special emphasis is placed on the important role the structure of the molecule plays in catalytic chemistry in petroleum refining processes. Special emphasis is also placed on some environmentally and economically significant compounds.

Model compounds of the selected molecular ensemble were in addition based on conditional arguments calculated from initial boiling point considerations and basic structural logic. Selection of the components is performed by considering first that each petroleum fraction can be represented by a finite number of true-components having boiling points within the boiling range of the petroleum cut. Naphtha feedstocks for example are typically the 20-200° C. distillates of the crude oil. These fractions are operationally defined, and therefore their exact boiling range is dependent upon the actual separation conditions. Consideration is also made to the molecular product fraction (i.e. paraffin, naphthene and aromatic content).

Some of the more general guidelines used for the selection of the molecular ensemble to represent the petroleum fraction relates to the boiling point. Straight run naphtha for example, which is the typical feedstock for gasoline production, consists of material boiling between pentane and kerosene distillate, comprising chiefly paraffinic, naphthenic, and aromatic hydrocarbons with 3 to 11 carbon atoms per molecule [15]. This corresponds approximately to a boiling range of 20 to 200° C. at 1 atm. Therefore, the model compounds must be composed of normal and isoparaffins, naphthenes, and aromatics ranging in carbon number from C₃ through C₁₁. This must include such compounds as Benzene, cyclopentane, cyclohexane and homologous series of these. In addition, if more than one isomer for a compound exists in the fraction then only one or two that best represents the physical and chemical properties of all the isomers is selected. Another criterion relates to the order of carbenium and carbonium ions that are likely to form during the kinetic modeling of catalytic cracking mechanism on bifunctional Zeolite catalysts which is important in kinetic research. Having satisfied the above criteria, the final molecular ensemble consisting of 68 molecular species shown in Table 2 were used to simulate petroleum naphtha.

The third step in this scheme comprises using mixing rules to calculate, from the predefined pure component data (molecular description, boiling points and composition), the concentration of the light components using the input RVP, then the composition of the heavier components using the PNA fractional composition and the boiling point distribution. The simulation outcome, in terms of molecular (boiling point) distributions and PNA fractional composition, is subsequently used to compare and contrast the experimental and analytical procedures described in step 1 above.

When molecular detail is available, it is possible to predict analytical results for multicomponent mixtures through simple accounting or methods for aggregating the molecules into lumped fractions. The properties in Table 3 calculated from global properties and aggregation of pure components must match otherwise model consistency and internal integrity is lost.

Molecular structure properties are computed by simply counting their occurrence with respect to composition. The averaged properties Θ are computed using weight, mole, or volume fractions as appropriate [15], where ƒ(Θ)ᵢ may be the property of pure component i or a function thereof.

$$Θ = {\sum }_{i = 1}^{n} f ( {Θ}_{i} ) {x}_{i} \qquad ( 5 )$$

Plurality of methods and equations are available for aggregating the properties of molecules using mixing rules for calculating global properties of mixtures are available in the literature the teachings of which are all incorporated herein by reference. Some of these are explained in details below.

For the surface tension, average molecular weight, pseudocritical temperature, critical compressibility factor, acentric factor, vapor pressure, refractive index, aniline point, freezing point and octane number, simple mole average method is used. A mass fraction average method is used for the heat of vaporization, the net heat of combustion, the isobaric heat capacity for vapor and liquid and Watson's characterization factor while volume fraction is used for the specific gravity.

For example, the molecular weight of the petroleum fraction can be calculated from the molecular weight of the pure components and their mole fractions using the following mixing rule,

$$M W = {\sum }_{i = 1}^{n} {( M W )}_{i} {( x )}_{i} \qquad ( 1 )$$

The average boiling points are calculated using the API recommended methods [1] as follows,

$$\begin{matrix}VABP = {\sum }_{i = 1}^{n} {x}_{vi} {T}_{bi} & ( 7 ) \\ MABP = {\sum }_{i = 1}^{n} {x}_{i} {T}_{bi} & ( 8 ) \\ WABP = {\sum }_{i = 1}^{n} {x}_{wi} {T}_{bi} & ( 9 ) \\ CABP = {( {\sum }_{i = 1}^{n} {x}_{vi} {T}_{bi}^{1 / 3} )}^{3} & ( 10 ) \\ MeABP = \frac{MABP + CABP}{2} & ( 11 )\end{matrix}$$

where VABP is the volumetric average boiling point, MABP is the molal average boiling point, WABP is the weight average boiling point, CABP is the cubic average boiling point, MeABP is the mean average boiling point, T_{bi} is the normal boiling point of component i (in K or °R), xᵥᵢ is the volume fraction of component i, xᵢ is the mole fraction of component i, and x_{wi} is the weight fraction of component i.

The Watson characterization factor is calculated using weight average [1] as follows

$${K}_{W} = {\sum }_{i = 1}^{n} {x}_{wi} {K}_{Wi} \qquad ( 12 )$$

The paraffin, naphthene and aromatics content is calculated by adding the mole, weight or the volume fraction of the compounds belonging to each group as follows,

$$Ω = {\sum }_{i = 1}^{{( n )}_{Ω}} {x}_{i ( Ω )} \qquad ( 13 )$$

while Ω is paraffin, naphthene, or aromatics content in either the weight, mole, or volume fraction, whereas, xᵢ is the weight, mole, or volume fraction, respectively.

The hydrogen content in mole fraction is calculated by adding the fractional amount of hydrogen atoms from all the molecules as follows,

$${H}_{2} = {\sum }_{i = 1}^{n} {{x}_{i} ( {n}_{{H}_{2}} )}_{i} \qquad ( 14 )$$

where xᵢ is mole fraction of molecular component i in the defined mixture and (n_{H2})ᵢ is the number of hydrogen atoms in molecule i.

For the critical temperature, critical and pseudocritical pressures, kinematic viscosity, and thermal conductivity simple linear mole, weight or volume averages are not appropriate and more intricate mixing rules must be used. The true critical temperature for the defined mixture is calculated from that of the pure components using the method of Li [16] by nonlinear averaging of the true critical temperature using surface fraction in the following equation,

$${Tc}_{m} = {\sum }_{i = 1}^{n} {Tc}_{i} {Φ}_{i} \qquad ( 15 )$$

where Φi is the surface fraction calculated as follows

$${Φ}_{i} = \frac{{x}_{i} {Vc}_{i}}{{\sum }_{j = 1}^{n} {x}_{j} {Vc}_{j}} \qquad ( 16 )$$

and, xᵢ is the mole fraction of component i, Vcᵢ is the critical volume of component i, Tcᵢ is the critical temperature of component i, and Tcₘ is the true critical temperature of the mixture.

For the pseudocritical pressure, a simple mole fraction average of the pure component critical pressure is normally not satisfactory. The simplest rules that gives acceptable results is the following combination [6],

$${Pc}_{m} = \frac{{RTc}_{m} ( {\sum }_{i = 1}^{n} {Zc}_{i} {y}_{i} )}{{\sum }_{i = 1}^{n} {Vc}_{i} {y}_{i}} \qquad ( 17 )$$

where T_{cm} is the pseudocritical temperature of the mixture, V_{ci} is the critical volume of component i, Z_{ci} is the critical compressibility factor of component i, yᵢ is the mole fraction of component i, and R is the ideal gas constant.

The true critical pressure for the defined mixture is calculated using the method of Chueh and Prausnitz by the modified Redlich-Kwong equation of state as follows [6],

$${Pc}_{T} = \frac{{RTc}_{T}}{{Vc}_{T} - {b}_{m}} - \frac{{a}_{m}}{{Tc}_{T}^{1 / 2} {Vc}_{T} ( {Vc}_{T} + {b}_{m} )} \qquad ( 18 )$$

where T_{cT} is the true critical temperature of the mixture, V_{cT} is the true critical volume of the mixture, R is the ideal gas constant, and aₘ and bₘ are constants to be determined from mixing rules and interaction parameters as outlines in the above reference.

The Kinematic Viscosity for the defined mixture at the standard temperature of 37.8 and 98.9° C. is calculated from that of the pure component's using nonlinear mole fraction averaging [1] in the following form,

$$ln {v}_{m} = {\sum }_{i = 1}^{n} {x}_{i} ln {v}_{i} \qquad ( 19 )$$

For the liquid thermal conductivity simple mole and mass fraction averaging was found to be equally effective in the following expression,

$$\frac{1}{{K}_{m}} = {\sum }_{i = 1}^{n} \frac{{x}_{i}}{{K}_{i}} \qquad ( 20 )$$

The fourth step in this scheme comprises using an optimization algorithm that calculates the optimum molecular composition of the simulated petroleum fraction. The objective function compares the true boiling point distribution of the petroleum fraction (from step 1) with those of the molecular representation (from step 3) while incorporating additional constraints from structural relations within the petroleum fraction such as the PNA fractional composition and other relations such as the vapor pressure to improve the simulation output and provide the model with a general validity. For that purpose, it was essential to allow for not only the initial transformation of feedstock characterization information into a molecular representation, but also the inverse transformation of molecular representation into global properties.

The distribution of the molecular ensemble in the MEPP model is determined in terms of volume fractions by minimizing the following objective function modified from that of the MECM model [2],

$$S = {\sum }_{j = 1}^{n} {( ( {Tb}_{j} - {T}^{′} {b}_{j} ) \times {W}_{o} \times 100 / {Tb}_{j} )}^{2} + {( ( PNA - {PNA}^{′} ) \times {W}_{1} \times 100 / PNA )}^{2} \qquad ( 22 )$$

where j is the index number of the molecule, and n is the total number of molecules. PNA is the paraffin, naphthene, and aromatic content for the petroleum fraction determined experimentally or calculated from experimental using generalized correlations with the bulk (global) properties as input parameters. PNA′ is the paraffin, naphthene, and aromatic content for the petroleum fraction calculated from aggregating pure components in the molecular ensemble using mixing rules. T′_{bj} is the boiling point of pure component j and T_{bj} is the boiling point value on petroleum fractions TBP curve corresponding to component j. W₀ is the weighting factor for the boiling points and W₁ is the weighting factor for the PNA fractional composition. S is the objective function to be minimized.

The objective function is taken as the sum of the square of the % error between the observed (experimental or otherwise predicted from experimental) TBP and PNA content of the petroleum fraction and those calculated from mixing (aggregating) the components of the molecular ensemble. The objective function consists of two parts. The first compares the boiling point of the pure component to the boiling point on the TBP curve of the petroleum fraction corresponding to the concentration (or cumulative volume %) of that component. By minimizing the objective function the difference between the boiling points is reduced by manipulating the composition of the molecular ensemble in the simulated mixture until each molecules boiling point matches that on the TBP curve.

The second part of the objective function compares the PNA fractional composition of the petroleum fraction and those from aggregation of the molecular ensemble. By minimizing the objective function the difference in these properties for the petroleum fraction and the molecular ensemble is reduced while the composition of the pure components in the molecular ensemble mixture simulating the petroleum fraction is calculated. As such the petroleum fraction is characterized using a molecular ensemble with average physical properties (e.g. specific gravity, molecular weight, etc) close to that of the petroleum fraction.

The above objective function may be expanded to all the parameters involved as follows,

$$S = {\sum }_{j = 1}^{n} {( ( {Tb}_{j} - {T}^{′} {b}_{j} ) \times {W}_{o} \times 100 / {Tb}_{j} )}^{2} + {( ( P \% - {P}^{′} \% ) \times {W}_{1} \times 100 / P \% )}^{2} + {( ( N \% - {N}^{′} \% ) \times {W}_{1} \times 100 / N \% )}^{2} + {( ( A \% - {A}^{′} \% ) \times {W}_{1} \times 100 / A \% )}^{2} + {( ( {P}^{v} - {P}^{′ v} ) \times {W}_{o} \times 100 / {P}^{v} )}^{2} \\ where \\ {P}^{′ v} = {\sum }_{i = 1}^{n} {P}_{i}^{v} \\ {P}^{′} \% = {\sum }_{i = 1}^{n} P {\%}_{i} = {\sum }_{i = 1}^{n} {X}_{i}^{P} \\ {N}^{′} \% = {\sum }_{i = 1}^{n} N {\%}_{i} = {\sum }_{i = 1}^{n} {X}_{i}^{N} \\ {A}^{′} \% = {\sum }_{I = 1}^{n} A {\%}_{i} = {\sum }_{i = 1}^{n} {X}_{i}^{A} \qquad ( 22 )$$

with the following constraints
Σxᵢ=1 and ∀xᵢ≧0
where P%, N%, A% is the mole percent of paraffin, naphthene, and aromatic content, respectively, in the petroleum fraction determined experimentally or calculated from experimental using generalized correlations with the global properties as input parameters while P′%, N′%, A′% are the paraffin, naphthene, and aromatic contents, respectively, for the petroleum fraction calculated from aggregating pure components in the molecular ensemble using mixing rules. P^{v} is the true vapor pressure of the petroleum sample determined experimentally or predicted from experimental and P′^{v} is the same calculated from aggregation of pure components in the molecular ensemble.

In the above objective function, both PNA′ and T_{bj} are a function of composition. The first utilizes the molecular composition in mixing rules while the second is a polynomial fit of the TBP curve of the petroleum fraction in which the composition is expressed in volume percent as follows:
T′_{bj}=T₀+aΨⱼ+bΨⱼ²+cΨⱼ³+dΨⱼ⁴ (23)
where a, b, c, d, and e are constants estimated by regression from the TBP curve of the petroleum fuel.

Alternatively the probability density function may be used in the following form [17].

$$\frac{{T}_{j} - {T}_{o}}{{T}_{o}} = {[ \frac{{T}_{1}}{{T}_{2}} ln ( \frac{1}{1 - {Ψ}_{j}} ) ]}^{1 / {T}_{3}} \qquad ( 24 )$$

where T₀, T₁, T₂ and T₃ are constants that can be estimated by regression using the TBP curve of the petroleum fraction.

In the above equations Ψⱼ is the cumulative volume fraction at the mid-volume percent of component j given by the following equation with xᵥ as the volume fraction,

$${Ψ}_{j} = {\sum }_{k = 1}^{j - 1} {x}_{vk} + \frac{{x}_{vj}}{2} \qquad ( 25 )$$

The mathematical fitting of the TBP curve in Equations 23 or 24 is a source of unlimited number of boiling point values to be compared with those of an unlimited number of molecules. Hence, there will always be an equal number of variables both independent (boiling points) and dependent (concentrations), using the true boiling point distribution alone, regardless of the number of molecules chosen. Therefore, no matter how many molecules are used in the ensemble, it is always possible to find a feasible solution.

It is very clear that the sum of the squares of the percentage errors of the boiling points in the first line of the objective function (Equation 21 or 22) is very much larger than that of the PNA content in the second line because the number of molecules in the ensemble, n, is 68. For that reason a weighting factor is used in each part of the objective function to give equal account of the other properties which will otherwise be overwhelmed by the errors from the boiling points of such a large number of molecules. Weighting factors associated with each term in the objective function was arrived at by trial and error which produced the best fit of experimental measurements. The optimum weighting factors W₁:W₀ values of 25:1 produce a very good reproduction of the TBP curve as well as the other global properties of the naphtha (e.g. the API gravity, molecular weight, and PNA content, etc). In the event that the number of molecules in the ensemble is reduced, W₁ must also be reduced to accommodate the changes and produce the minimum error possible. Once the optimum values of the weighting factors are determined, they are kept constant as part of the procedure since they are a function of the number of both molecules and properties considered.

The molecular group-type (paraffins, naphthenes and aromatics) fractional composition for the naphtha can be obtained experimentally using gas chromatography. Alternatively, when experimental data is not available, these structural relations may be predicted, from the conventional properties, using methods in the literature. The API-TDB EPCON software based method [18] may be used to obtain an estimation of the PNA fractional composition of feed fractions. The PNA fractional composition can also be determined using the generalized method proposed by Riazi and Daubert [19]. It is our observation that the API-TDB EPCON method is more accurate in representing the experimental data, however, in order to automate the procedure, the method of Riazi and Daubert was incorporated in the MECM model. This method estimate the mole fractions of the paraffins, X_{P}, naphthenes, X_{N} and aromatics, X_{A}, using the following equations,
X_{P}=−23.94+24.21Rᵢ−1.092VGF (26)
X_{N}=41.14−39.43Rᵢ+0.672VGF (27)
X_{A}=−16.2 +15.22Rᵢ+0.465VGF (28)
Rᵢ=n−(d/2) (29)
RI=[(1+2i)/(1−i)]^{0.5} (30)
VGF=−1.816+3.484SG−0.1156υ₃₈ (31)
where Rᵢ is the refractivity intercept, RI is the refractive index at 20° C., d is the density in g/cm³ at 20° C. and 0.1 MPa, VGF is the viscosity gravity function, SG is the specific gravity at 15° C., and υ₃₈ is the kinematic viscosity at 38° C. in mm²/s.

It is evident from experimental data that ASTM D86 distillation cannot account for the concentration of the components lighter than C₅ due to evaporation at room temperature during the experimental procedure as well as sampling. The concentration of the light ends (n-butane and lighter) in naphtha is calculated using simple phase equilibrium calculations.

First, the RVP for the petroleum fraction (naphtha) is obtained experimentally. Alternatively, RVP may be estimated using the Riazi-Albahri equation, [20]

$$RVP = {P}_{cp} exp ( Y ) \\ Y = - X ( \frac{{T}_{b} SG}{{T}_{r}} ) {( 1 - {T}_{r} )}^{5} \\ X = - 276.7445 + 0.06444 {T}_{b} + 10.0245 SG - 0.129 {T}_{b} SG + \frac{9968.8675}{{T}_{b} SG} + 44.6778 ln {T}_{b} + 63.6683 ln SG \\ {T}_{r} = 311 / {T}_{cp} \qquad ( 32 )$$

where T_{cp} and P_{cp} are the pseudocritical temperature and pressure of the petroleum fraction in degrees Kelvin and bar, respectively. SG is the specific gravity at 15.5° C. (15.6° C.), RVP is in bars and T_{b} is the normal boiling point in degrees Kelvin.

The experimental or otherwise estimated RVP is converted into true vapor pressure (TVP) at 37.8° C. (37.8° C.) using the API method [1] that has been digitized and incorporated into the MECM model specifically for that purpose. The TVP is then used to calculate the concentration of the light ends in the naphtha using simple bubble (boiling) point calculations the criteria for which is the following;

$${\sum }_{i = 1}^{n} {K}_{i}^{′} {x}_{i} = 1 \qquad ( 33 )$$

The vapor-liquid equilibrium constant (distribution coefficient) is simplified for ideal systems using Raoult's law to the following relation,
K′ᵢ=Pᵢ^{v}/Pₜ (34)
where, Pᵢ^{v} is the vapor pressure of the pure component i in the defined mixture and Pₜ is the true vapor pressure of the naphtha at 37.8° C. (37.8° C.).

Combining the above equations, the following simple relation is obtained;

$${\sum }_{i = 1}^{n} {P}_{i}^{v} {x}_{i} = {P}_{t} \qquad ( 35 )$$

which can be incorporated in the objective function (Equation 21 or 22) and used to calculate the mole fraction of the light ends.

A multivariable optimization algorithm is used to minimize the objective function while calculating the concentration of the pure components. After calculating the objective function, the optimization technique alters the concentration until the minimum is found. This point represents the optimal concentrations which best fit the basic analytical data and quantitatively represents the naphtha sample.

Nearly all classical nonlinear optimizers are guaranteed only to find a locally optimal solution. To find a globally optimized solution, using for example the nonlinear GRG local optimization module, an alternative approach is usually used. The optimization program is run several times from judiciously chosen but different starting points, and the best solution found will be the best estimate of a globally optimized solution. Making use of this multi-start technique is often used to get an estimate of the solution uniqueness [21].

Although it is argued that the model outcome in terms of molecular distributions and predicted average global properties has very little sensitivity to variations in feed molecular representation [21] it is better to employ a global optimization algorithm whenever possible to ensure uniqueness of the results and avoid lengthy trial-and-error procedures as well as errors resulting from non-judicial initial assumption. Although it is not possible to theoretically guarantee global minimum for nonlinear function unless the function is convex which is not always the case.

The optimization algorithm, written in MS EXCEL™ macro, is applied using the PC version of “Frontline Systems Premium Solver Platform 6.0” software package [22] in order to search for the unknown vector (x) that minimizes the objective function (S) and satisfies the constraints. The mathematical solver employs the LGO global solver engine in the optimization toolbox to minimize the objective function. The parameter to be optimized is the volume percent, xᵢ (i.e. concentration) of the molecules in the simulated petroleum fraction. Using the Solver engine and the nonlinear large-scale global optimization (LGO) code, convergence was achieved in about 7 seconds for each case on a Pentium IV-3.0 GHz PC.

The fifth step in this scheme comprises converting the pure component data (molecular description, physical properties, and calculated composition) into global properties (e.g. molecular weight and H/C content, etc) using mixing rules. When molecular detail is available, it is possible to predict analytical results for multicomponent mixtures through simple accounting or methods for aggregating the molecules into lumped fractions. Molecular structure properties are computed by simply counting their occurrence with respect to composition. The averaged properties Θ are computed using weight, mole, or volume fractions as appropriate [15], where ƒ(Θᵢ) may be the property of pure component i or a function thereof,

$$Θ = {\sum }_{i = 1}^{n} f ( {Θ}_{i} ) {x}_{i} \qquad ( 36 )$$

The sixth step in this scheme comprises the testing phase. To verify the validity and accuracy of the MEPP model the simulation outcome in terms of average global properties of the petroleum fraction are compared to those calculated using generalized correlations from the literature. A total of 30 naphtha samples were collected to assess model performance against experimental data and for error analysis [2, 23]. The experimental data cover a wide array of light and heavy petroleum naphtha ranging in API gravity from 35 to 94, initial boiling point from 16.7 to 130.6° C. and final boiling point from 66.7 to 155.5° C.

The procedure used to test the model is as follows. The naphtha input to the model is characterized in terms of bulk properties (RVP, PNA, and ASTM D86 distillation). The MECM model is used to generate a molecular ensemble that retains the qualitative features expected to mimic the naphtha. The predicted molecular distributions are aggregated in the MEPP model to calculate the global properties (API, MW, viscosity, etc). The model performance in simulating the actual petroleum fraction is compared to products from generalized correlations which use the contemporary method of feed characterization. Error analyses are presented by comparing the global properties of the petroleum fraction obtained experimentally or predicted from experimental using the methods summarized in Albahri [2].

The ultimate output of the program is the global properties of light petroleum fractions from the knowledge of their conventional laboratory analysis such as RVP, and PNA content and ASTM D86 distillation, with the latter being the minimum input required.

Therefore, when a petroleum naphtha sample is being tested for boiling point distillation the other properties of the sample are also measured.

The accuracy of the model is verified by the validation model the purpose of which is to cross check the proposed method and validate its result by comparing its performance with other methods for determination of petroleum fractions global properties from the literature. The validation model comprises methods for determination of global Properties of the petroleum fractions. The global property equations are obtained from the literature, explained in details below, the teachings of which are all incorporated herein by reference.

The determination of the petroleum fractions global properties involves either accessing standard correlations or simulating various thermodynamic experiments. Several charts and correlations in the literature predict the physical, thermodynamic, and transport properties of undefined mixtures based on properties such as the boiling point, specific gravity, and some characterization factors. Examples of such charts and correlations are available in the API-TDB [1] and other references [4, 6, 19, 24, 25, 26].

The global properties used in the MEPP model and their estimation methods are shown in Table 2. First property estimation software packages such as PETROCHEM [27] and EPCON API-TDB [18] in addition to some API procedures were used to obtain quick reliable answers during model development and solution. Alternate methods were additionally obtained from various sources, as discussed below, including the API-TDB [1]. All the relevant API figures and procedures were digitized in order to automate the calculations for the purpose of carrying out the intended study [28].

A measure of petroleum oil density is expressed in the United States as API, where API gravity is related to specific gravity (SG) at 15.6° C. as follows,

$$API = \frac{141.5}{SG} - 131.5 \qquad ( 37 )$$

The most commonly used characterization factor of the petroleum fraction is that proposed by Watson [1] which is an index of paraffinicity of the sample. The Watson, also known as the UOP, characterization factor which requires the mean average boiling point (MeABP) in Rankin and the standard specific gravity (SG) at 15.6° C. is defined as follows,

$${K}_{w} = \frac{{MeABP}^{1 / 3}}{SG} \qquad ( 38 )$$

The molecular weight of light petroleum fractions (where the specific gravity is less than 0.97 and the average boiling point is less than 840 K) can be calculated using the API recommended equation [15] which requires only the mean average boiling point (T_{b}) in Kelvin and the standard specific gravity (SG) of the petroleum fraction.
MW=42.965(T_{b}^{1.26007}SG^{4.98308})
[exp(2.097.10⁻⁴T_{b}−7.78712SG+2.08476.10⁻³T_{b}SG)] (39)

The liquid thermal conductivity at 25° C. for the petroleum fractions is calculated using the following correlation [29],
λ=2.540312(SG/T)^{0.5}−0.0144485 (40)

Where, λ is the thermal conductivity in W/(m.K), T is the temperature in Kelvin (298 K), and SG is the specific gravity.

The viscosity of petroleum oil at the standard temperatures of 37.8 and 98.9° C. can be estimated using the following relations by Abbott et al.[15],

$$\begin{matrix}log {v}_{100} = 4.39371 - 1.94733 {K}_{w} + 0.12769 {K}_{w}^{2} + 3.2629 \cdot {10}^{- 4} {API}^{2} - 1.18246 \cdot {10}^{- 2} {K}_{w} API + \frac{( 8.0325 \cdot {10}^{2} {K}_{w} + 1.24899 API + 0.19768 {API}^{2} )}{( API + 26.786 - 2.6296 {K}_{w} )} & ( 41 ) \\ log {v}_{210} = - 0.463634 - 0.166532 API + 5.13447 \cdot {10}^{- 4} {API}^{2} - 8.48995 \cdot {10}^{- 3} {K}_{w} API + \frac{( 8.0325 \cdot {10}^{2} {K}_{w} + 1.24899 API + 0.19768 {API}^{2} )}{( API + 26.786 - 2.6296 {K}_{w} )} & ( 42 )\end{matrix}$$

where K_{w} is Watson's characterization factor given by Equation 6, API is API gravity given by Equation 37, ν_{37.8} is the viscosity at 37.8° C. and ν_{98.9} is viscosity at 98.9° C. both in mm²/s, and log is the common logarithm (base 10).

The pseudocritical temperature (T_{cp}), pseudocritical pressure (P_{cp}) and the acentric factor (ω) of petroleum oil can be estimated by the methods of Lee-Kessler [26] as follows,

$$\begin{matrix}{T}_{{c}_{p}} = 189.8 + 450.6 SG + {T}_{b} ( 0.4244 + 0.1174 SG ) + \frac{( 14 \text{,} 410 - 100 \text{,} 688 SG )}{{T}_{b}} & ( 43 ) \\ ln {P}_{{c}_{p}} = 5.68925 - \frac{0.0566}{SG} - {10}^{- 3} {T}_{b} ( 0.436392 + \frac{4.12164}{SG} + \frac{0.213426}{{SG}^{2}} ) + {10}^{- 7} {T}_{b}^{2} ( 4.75794 + \frac{11.819}{SG} + \frac{1.53015}{{SG}^{2}} ) - {10}^{- 10} {T}_{b}^{3} ( 2.45055 + \frac{9.901}{{SG}^{2}} ) & ( 44 ) \\ ω = - 7.904 + 0.1352 {K}_{w} - 0.007465 {K}_{w}^{2} + 8.359 {T}_{br} + \frac{( 1.408 - 0.1063 {K}_{w} )}{{T}_{br}} & ( 45 ) \\ {T}_{br} = \frac{{T}_{b}}{{T}_{c}} & ( 46 )\end{matrix}$$

where T_{cp} is the pseudocritical temperature in Kelvin, P_{cp} is the pseudocritical pressure in bar, ω is the acentric factor, T_{b} is the normal boiling point in Kelvin, SG is the standard specific gravity, T_{br} is the reduced boiling point temperature from Equation 46, K_{w} is Watson's characterization factor, T_{c} is the critical temperature in Kelvin, and In is the Napierian logarithm.

The isobaric specific heat for a liquid petroleum fraction is estimated by the 1933 correlation attributed to Watson and Nelson [15],
Cpₗ=4.185(0.35+0.055K_{w})(0.3065−0.16734SG+T(1.467×10⁻³−5.508×10⁻⁴SG)) (47)
where K_{w} is Watson's characterization factor, SG is the standard specific gravity, T is the temperature in Kelvin, and Cpₗ is the isobaric mass specific heat for liquid in KJ/(kg.K).

The isobaric vapor heat capacity at 15.6° C. is obtained using the method of Lee-Kessler [15] also cited in the API technical data book [1],

$${Cp}_{g} = 4.185 ( B + 3.6 C T + 9.72 {DT}^{2} ) \\ B = - 0.35644 + 0.02972 {K}_{w} + α ( 0.29502 - \frac{0.2846}{SG} ) \\ C = \frac{- {10}^{- 4}}{2} ( \begin{matrix}2.9247 - 1.5524 {K}_{ w} + \\ 0.05543 {K}_{ w}^{ 2} + α ( 6.0283 - \frac{5.0694}{ SG} )\end{matrix} ) \\ D = \frac{- {10}^{- 7}}{3} ( 1.6946 + 0.0844 α ) \\ α = 0 unless 10 < {K}_{w} < 12.8 and 0.7 < SG < 0.885 then \\ α = {[ ( \frac{12.8}{{K}_{w}} - 1 ) ( 1 - \frac{10}{{K}_{w}} ) ( SG - 0.885 ) ( SG - 0.7 ) \times {10}^{4} ]}^{2} \qquad ( 48 )$$

where Cp_{g} is the specific heat of petroleum fraction in the ideal gas state in KJ/(kg.K), T is the temperature in Kelvin, K_{w} is Watson's characterization factor, SG is the standard specific gravity and B, C, and D are coefficients.

The research and motor octane numbers (RON and MON) for the naphtha were obtained experimentally. When experimental values for RON are not available they are determined by the graphical method of Nelson [30] which we have digitized. The correlation requires the mid-boiling point of gasoline and either the paraffin content or the Watson characterization factor. The motor octane number (MON) is estimated from the following correlation derived from that proposed by Jenkins [31] for olefin free fuels,
MON=22.5+0.83RON−20.0SG (49)
where SG is the specific gravity of the fuel at 15.5 ° C.

The net heat of combustion in KJ/Kg is calculated using the correlation of Gorenkov et al. [32] for the net heat of combustion ofjet fuels which is modified here for naphtha in the following form,

$$Δ {H}_{c} = 35 \text{,} 696 + 94.87 ( {X}_{A} ) - 9.44 ( {T}_{ave} ) - 0.35 ( {X}_{A} ) ( {T}_{ave} ) + \frac{5 \text{,} 525 - 111.1 ( {X}_{A} ) + 10.15 ( {T}_{ave} ) + 0.377 ( {X}_{A} ) ( {T}_{ave} )}{0.001 ρ} \qquad ( 50 )$$

where X_{A} is the content of aromatic hydrocarbons in wt % and Tₐᵥₑ is the average boiling point of the fuel, equal to ⅓ the sum of the 10%, 50%, and 90% distillation points in ° C. and ρ is the fuel density at 20° C. in kg/m³.

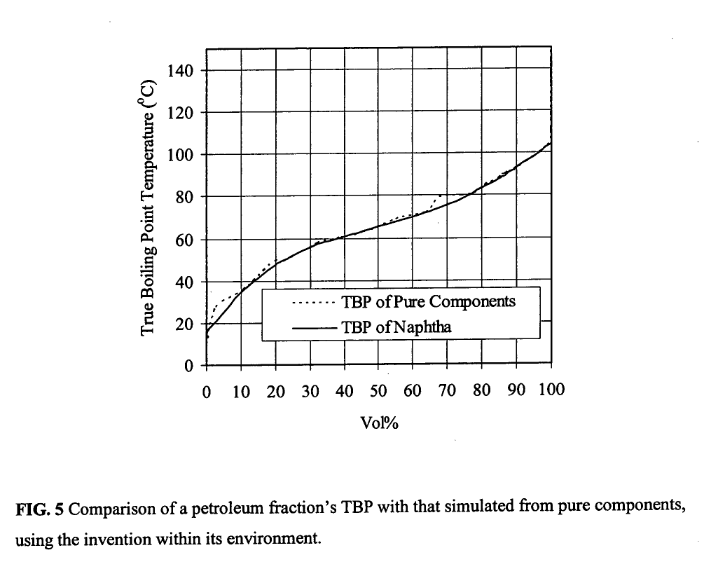

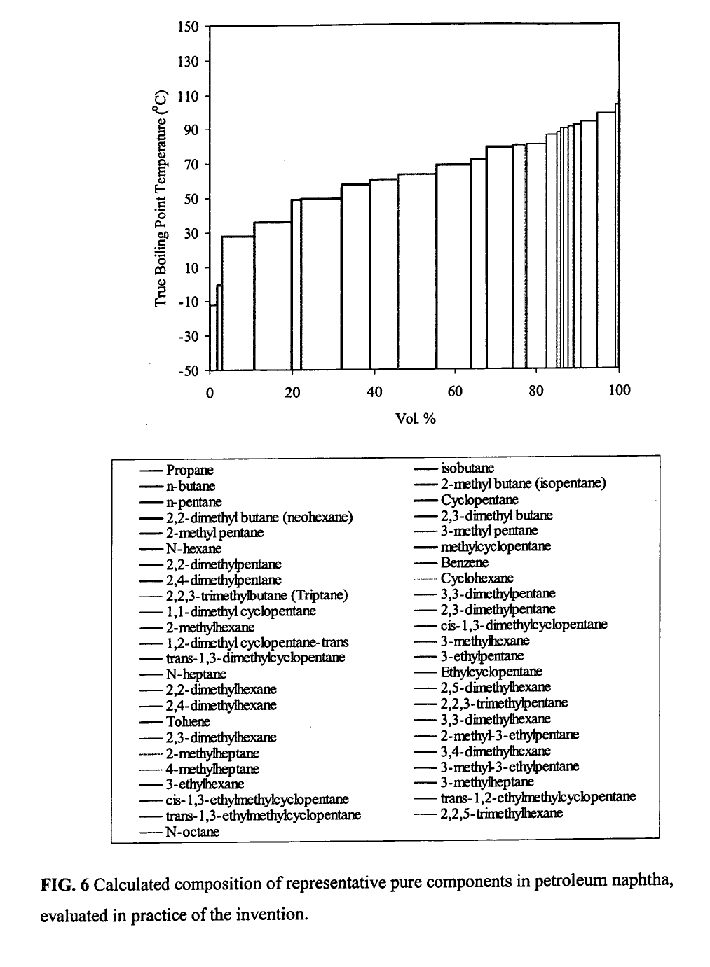

For this example, the ASTM D86 distillation data of petroleum naphtha was used to construct an ensemble of explicit molecular structures using the MECM model. These molecules were subsequently used according to the procedure described above to compute molecular distribution results, the boiling point distribution of which was estimated by fitting to the petroleum fractions TBP curve. FIG. 5 compares the overall experimentally measured boiling point distribution with that predicted from the MECM simulation for petroleum naphtha. The components results demonstrate an almost exact match with the TBP curve to within statistical errors. This was to be expected in that the input distribution was directly derived from the experimental distribution. Nevertheless, the two TBP curves do not match exactly. There is a small deviation due to optimization of other properties (RVP and PNA content) in addition to the boiling points. To illustrate the fine-grained molecular detail of the output, the molecular distribution for 68 species used to simulate a naphtha feed for one case is shown in FIG. 6.

Using the MEPP methods and correlations to determine the petroleum fractions global properties, the PNA compositions and physical properties of one of the samples (petroleum naphtha reformate fraction) are estimated and tabulated in Table 3. The same properties estimated from aggregation of the molecular ensemble for the MEPP simulated petroleum fraction are also shown in the same table. The percent deviations of these estimated properties are also shown. The small deviations indicate how the MEPP estimated properties are representative of the undefined petroleum mixture.

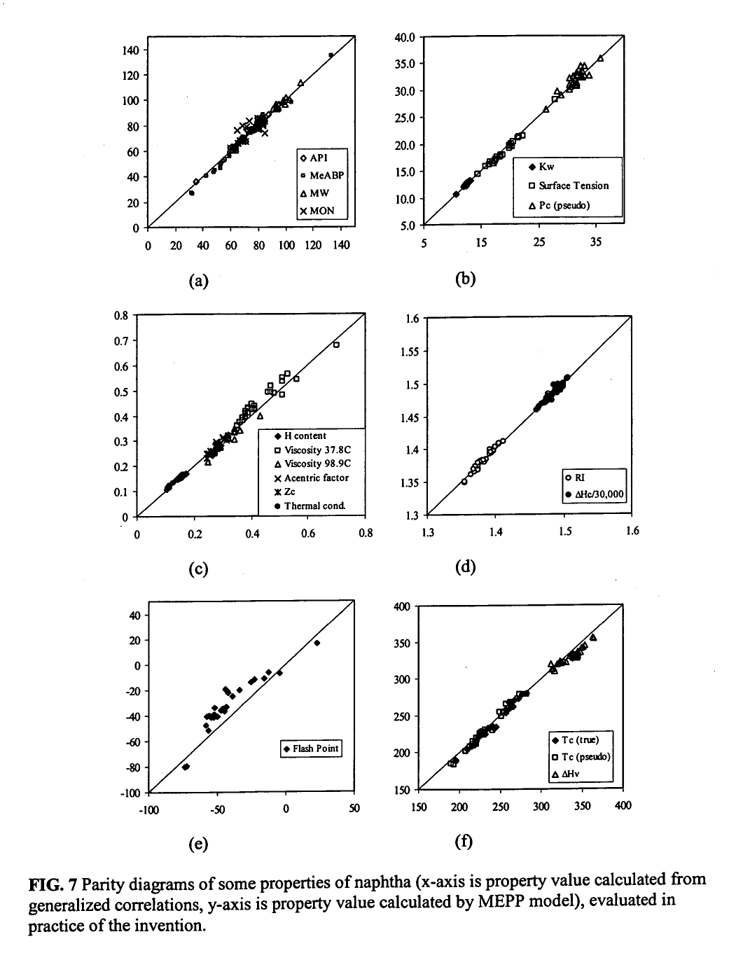

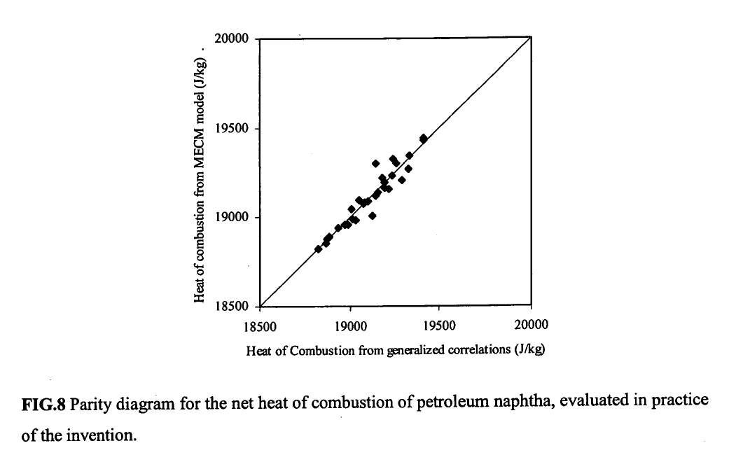

Detailed comparison for some selected properties for all naphtha samples are shown in the summary presented in Table 3 and the parity diagrams in FIG. 7 and 8. The fit between the experimental and stimulation results as shown by the average percentage errors and correlation coefficients is quite good. The average absolute deviation for all the properties in Table 3 is about 3.5% and the average correlation coefficient is 0.96.

The RVP and PNA fractional composition results demonstrate an almost exact match to within statistical errors. This was to be expected in that the input distribution was directly derived from the experimental distribution. From all the properties investigated, the true vapor pressure at 37.8° C., the specific (API) gravity, molecular weight, surface tension of liquid at 25° C., Watson characterization factor, refractive index, hydrogen content, kinematic viscosity at 37.8 and 98.9° C., true critical temperature, pseudocritical temperature, pseudocritical pressure, acentric factor, the liquid thermal conductivity at 25° C., flash point, net heat of combustion at 25° C., heat of vaporization at the normal boiling point, and the mean, cubic, weight, molar, and volume average boiling points correlated very well as evident by the average percentage errors and correlation coefficients that were in the upper nineties. This indicates how good the feed modeling and characterization by the proposed technique are. Less accurate but still good predications were for the aniline point, motor octane number, and critical compressibility factor with correlation coefficients ranging between 0.8 and 0.9 and with average percentage errors of 5.38% or less which is also good.

Differences between the conventional and simulated results may be cause by inconsistencies in the data provide by the analytical tests, approximations made during construction of the MEPP model including the choice of the molecular ensemble, and inherent errors in the various correlations used. Nevertheless, for the majority these are within experimental errors.

Although the MEPP model predictions for the aniline point and critical compressibility factor do not show as good correlation as the other properties in Table 3, the average percentage error for the two properties is quite acceptable. The model predictions for MON shows promise for further improvement with using interaction parameters since this property does not mix linearly with composition because of the synergistic and antagonistic effect the molecules possess when they are present together.

The steady state MEPP simulation of the petroleum naphtha systems was run successfully on Pentium IV personal computer running at 3.0 GHz. The CPU time of the simulation to characterize the petroleum naphtha feed into molecular ensemble and recalculate its global properties by aggregating the molecular ensemble was in the order of 10 seconds. The CPU time required to predict the properties of the feed was proportional to the number of molecules simulated. For this reason, it was efficient to simulate the fewest molecules possible that accurately described the petroleum naphtha fraction. Increasing the number of molecules, results in a more accurate estimates of the fraction bulk properties. Therefore, the larger the sample size, the smaller the sample variance; in other words the average property is a better estimate of the true simulated property. A sample size of 68 molecules offers an accurate estimate of the feedstock properties and allows for the future incorporation of reaction kinetic models at a reasonable computation expense.

### EXAMPLE 2

### Property Prediction of Petroleum Fractions Using the Pseudocomponent Method

According to the method of the present invention, the boiling point distribution, such as that obtained from the ASTM D86 distillation for example, is first fitted to any form of algebraic equation such as the probability density function, PDF, (Equation 24) or a fourth order polynomial function (Equation 23), and the like with the latter being more preferred. This is used to generate a multitude of boiling point values (T_{bi}) at desired values of the samples volume % distilled.

The property of the petroleum fraction is calculated using the following equation,
Property=Σ(xᵥ)ᵢ(PVBI)ᵢ where i=1, 2, 3, . . . , n (51)
where (xᵥ)ᵢ is the volume fraction of the pseudocomponent cut, n is the number of pseudocomponent cuts, and (PVBI)ᵢ is the property volume blending index of cut i given by the following quadratic equation,
(PVBI)ᵢ=a+b(T_{b})ᵢ+c(T_{b})ᵢ² (52)

The property volume blending index could be the specific gravity for example, (Tb)i is the boiling point value from the ASTM D86 distillation curve corresponding to the mid volume percent of the pseudocomponent cut i.

Mole and weight blending indexes may also be used in Equation 51 with the volume blending index being more preferred. In that case appropriate weight, mole, or volume fraction averaging or blending method may be used. Furthermore, other linear averaging methods of the volume, weight, or mole blending indexes may be used instead of the simple linear averaging. Non-linear averaging is also possible either in terms the mole, weight, and volume fractions or in terms of the weight, weight, and volume blending indexes, or both.

For calculating the specific gravity of the petroleum fraction for example, Equation 52 is used to calculate the specific gravity volume blending index (SGVBI)ᵢ, where T_{bi} is in degrees C, using the following constants determined by regression from experimental data and the least square method,
a=0.640500305 b=0.000847828 c=−4.84E-07

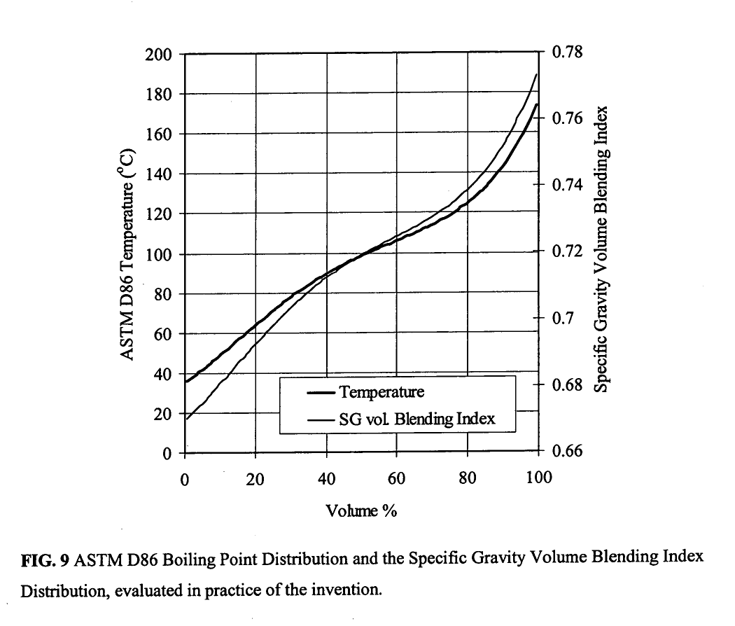

The distribution of the specific gravity volume blending index (SGVBI)ᵢ is shown with that of the ASTM D86 boiling point temperature in FIG. 9. A quadratic equation was good enough to capture the distribution of the SG volume blending index. There was no need for a higher order polynomial function since the constant for the third and fourth order parameters were evaluated by regression as nil.

Choosing 100 volume-based pseudocomponents with a one volume % cut each (xᵥᵢ=0.01), the specific gravity is calculated from Equation 51 by simply volume-averaging the (SGVBI)ᵢ for the 100 cuts at cumulative mid-volume % values of 0.5, 1.5, 2.5, . . . ,99.5 as follows,
SG=Σ(SGVBI)ᵢ, where i=1, 2, 3, . . . , 100 (53)

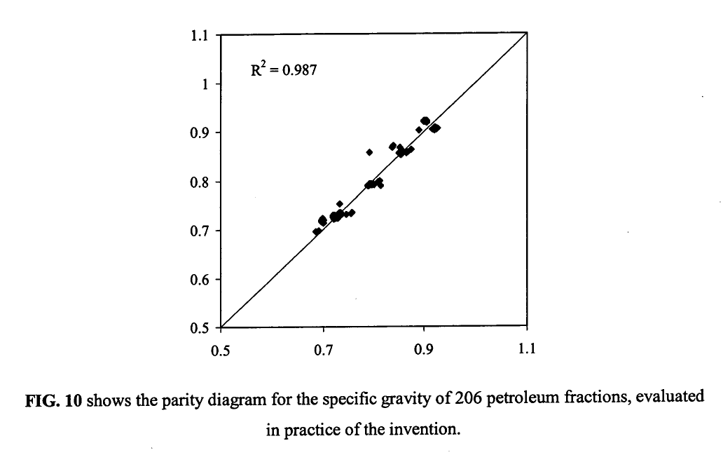

Having tested the above procedure to predict the SG of 206 petroleum fractions comprising naphtha, kerosene, diesel, and heavy gasoil, with the boiling point ranging from 30 to 540° C. and API from 20 to 75 and SG from 0.6849 to 0.9248, the predicted specific gravities for these petroleum fractions are plot against experimental data in the parity diagram in FIG. 10 with a correlation coefficient of 0.987. The average absolute deviation is 0.0091 and the absolute average percentage error is 1.12% which is well within experimental error. The maximum deviation and error are 0.0647 and 8.16%, respectively.

It is possible to choose a lesser number of pseudocomponents with equal volume % for each. For example, one may choose 50 pseudocomponents with two volume percent each. Then the volume index is calculated at cumulative mid volume % values of 1, 3, 5, . . . , 99, and so forth. It is also possible to choose non-equal volume % for each pseudocomponent.

The above pseudocomponent model can be simplified without parting from the teachings and claims of the present invention, assuming the whole petroleum fraction comprises five volume-based pseudocomponent cuts with 20 volume % each. The mid-volume boiling point of cut 1 is equal to the 10% distillation temperature (T₁₀). The mid-volume boiling point of cut 2 is equal to the 30% distillation temperature (T₃₀). The mid-volume boiling point of cut 3 is equal to the 50% distillation temperature (T₅₀). The mid-volume boiling point of cut 4 is equal to the 70% distillation temperature (T₇₀). The mid-volume boiling point of cut 5 is equal to the 90% distillation temperature (T₉₀). This conveniently ignores the IBP and FBP since they are usually not as accurately determined as the other boiling point temperatures by the ASTM D86 distillation test.

In this case the specific gravity is calculated from Equation 51 by simply adding the volume weighted (averaged) (SGVBI)ᵢ for the 5 pseudocomponent cuts evaluated at the boiling point temperatures corresponding to the 10, 30, 50, 70, and 90 cumulative mid-volume percents as follows,
SG=Σ(xᵥ)ᵢ(SGVBI)ᵢ, where i=20, 40, 60, 80, 100 (54)
where SG is the specific gravity of the petroleum fraction, xᵥᵢ is the volume fraction of each pseudocomponent which is 20% or 0.2 weight fraction and (SGVBI)ᵢ is the specific gravity volume blending index given by the following quadratic equation obtained by regression from experimental data,
(SGVBI)ᵢ=0.620810874+0.001038583(T_{bi})−8.94E-07(T_{bi})² where i=10, 30, 50, 70, 90 (55)
where T_{bi} is the ASTM D86 boiling point temperature in degrees C corresponding to 10, 30, 50, 70, and 90 volume % vaporization of the sample.

Calculating the (SGVBI)ᵢ at 10, 30, 50, 70, 90 volume % temperatures then substituting into Equation 54, the final expression for the specific gravity of the petroleum fraction in terms of the ASTM D86 boiling point temperatures is given by the following expression with almost the same accuracy as the detailed model,
SG=0.620810874+0.0002077166(T₁₀+T₃₀+T₅₀+T₇₀+T₉₀)−1.788E-07[(T₁₀)²+(T₃₀)²+(T₅₀)²+(T₇₀)²+(T₉₀)²] (56)

The predicted specific gravities for the above petroleum fractions are contrasted against experimental data with a correlation coefficient of 0.991, an average absolute deviation of 0.0038, and an absolute average percentage error 0.93% which is well within experimental error and a maximum deviation and error of 0.0296 and 3.53%, respectively.

Equation 56 is useful when complete boiling point distribution is available and excessive computation is not desirable. Calculations can be done by hand and pocket calculator without the need for a computer. This and other equations using the petroleum fractions boiling point distribution, available in the literature, are incorporated herein by reference and may be used for the purpose of the present invention.

The above model can be further be simplified without parting from the teachings and claims of the present invention by assuming the whole petroleum fraction as one pseudocomponent cut with 100 volume % and a mid-volume boiling point equal to the 50% distillation temperature. Applying the above assumption reduces the whole model to the following single equation with almost the same accuracy as the detailed model,
SG=0.61830388+0.001072356(T₅₀)−9.68E-07(T₅₀)² (57)
where, SG is the specific gravity of the petroleum fraction and T₅₀ is the ASTM D86 boiling point temperature in degrees C corresponding to 50 volume % vaporization of the sample. This equation is useful when complete boiling point distribution is not available.

The predicted specific gravities for the above petroleum fractions using Equation 57 compared against the experimental data with a correlation coefficient of 0.991, an average absolute deviation of 0.0033, and an absolute average percentage error 0.87% which is well within experimental error and a maximum deviation and error of 0.0306 and 3.64%, respectively. This and other equations using a single or average boiling point, available in the literature, are incorporated herein by reference and may be used for the purpose of the present invention.

Although Equations 56 and 57 are comparable in terms of average percentage error and correlation coefficient, the former is more preferred when complete boiling point distribution is available.

The above procedure can be applied to predict other properties of the petroleum fraction such as the freezing point, the Reid vapor pressure, the molecular weight, and the like, and in particular to predict the mass, mole or volume specific properties such as enthalpy, heat capacity, molecular weight, heat of combustion, heat of vaporization by calculating through regression from appropriate experimental data the values of the constants of Equation 52; a, b, and c or any other appropriate equation including non-quadratic. The boiling point distribution may as well be the true boiling point distribution or any boiling point distribution obtainable from a distillation device, a gas chromatograph, or infrared spectroscopy or the like since inter-conversion between these is well established in the literature or can be easily developed by those skilled in the art without further experimentation.

### EXAMPLE 3

### Property Prediction of Petroleum Fractions Using Neural Networks

An artificial intelligence system can be used with a conglomeration of boiling point distribution data to provide a method of improving recognition of an unknown from its boiling pattern. Customized neural network systems allow the ultimate organization and resourceful use of variables already existing in the distillation apparatus for a much more comprehensive, discrete and accurate differentiation and matching of boiling point than is possible with human memory. The invention provides increased speed of fingerprinting analysis, accuracy and reliability together with a decreased learning curve and heightened objectivity for the analysis.

Characteristic boiling point distributions are obtained for the materials via distillation techniques including ASTM D86, ASTM D1160, and the like. Desired portions of the boiling point distribution may be selected and then placed in proper form and format for presentation to a number of input layer neurons in an offline neural network. The network is first trained according to a predetermined training process; it may then be employed to identify the properties of particular materials in-situ or in real time.

An apparatus comprising such mathematical model is particularly useful for recognizing and identifying organic compounds such as complex hydrocarbons, whose properties conventionally require a high level of training and many hours of hard work to identify, and are frequently indistinguishable from one another by human interpretation.

### Specific Gravity

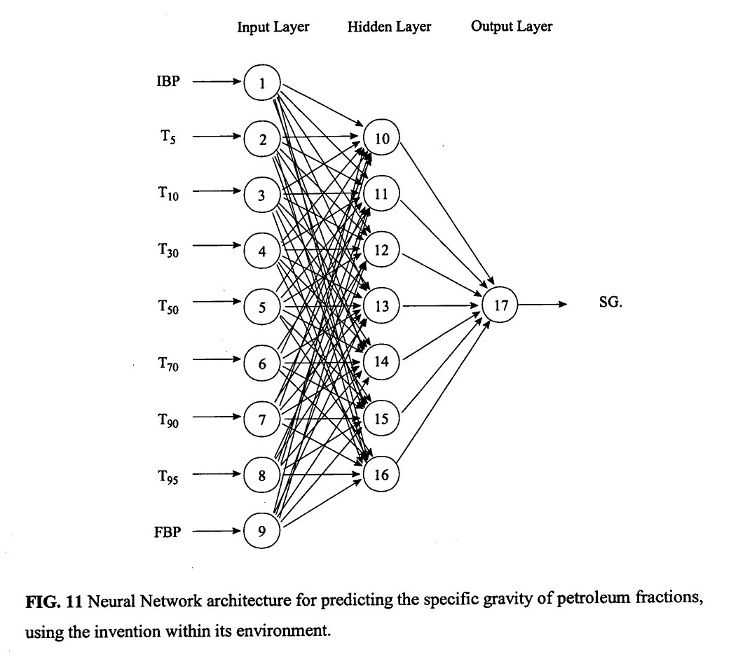

Using the back-propagation neural network architecture shown in FIG. 11 with an input layer comprising nine neurons representing the boiling point temperatures obtained from distillation according to the method of the present invention and one hidden layer comprising seven neurons with the sigmoid transfer function. The specific gravity of the 176 petroleum fractions in Example 2 were used to train the network and 30 were used to test the trained network.

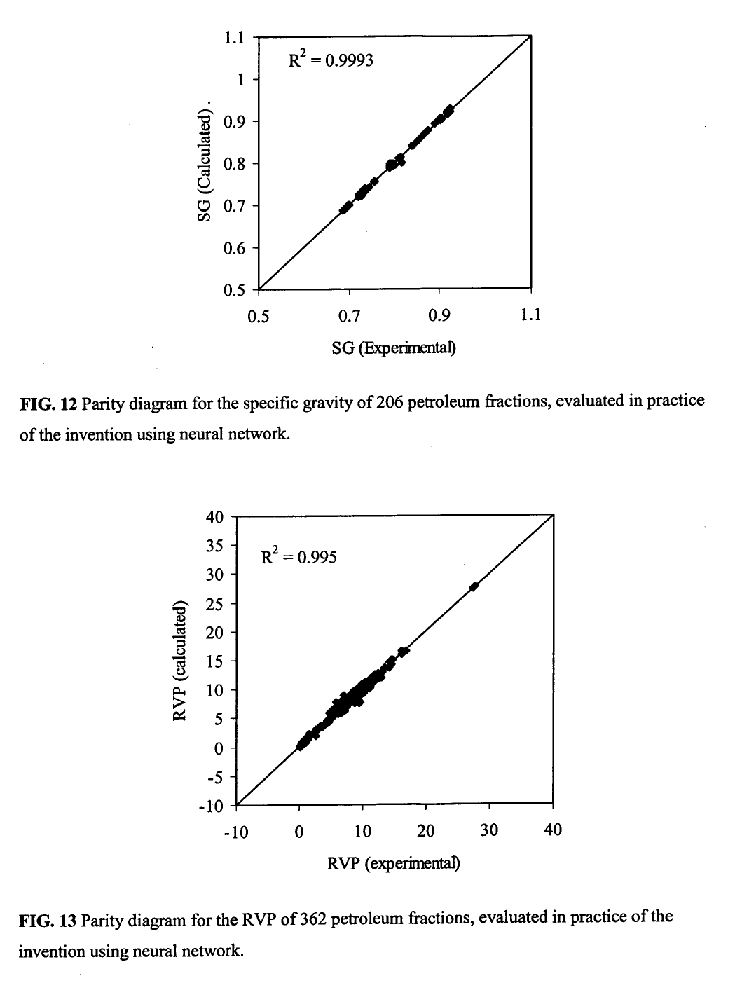

The predicted specific gravities for these petroleum fractions is plot against experimental data in the parity diagram of FIG. 12 with an overall correlation coefficient of 0.9993 (for the combined training and testing sets) and an overall absolute average percentage error 0.172% and a maximum error of 1.71% which is very accurate.

The above procedure can be applied to other properties of the petroleum fraction such as the freezing point, the Reid vapor pressure, the molecular weight, and the like by training the neural networks from appropriate experimental data. The boiling point distribution may as well be the true boiling point distribution or any boiling point distribution obtainable from a distillation device, a gas chromatograph, or infrared spectroscopy or the like since Inter-conversion between these is well established in the literature or can be easily developed by those skilled in the art without parting from the teachings of the present invention or further experimentation.

The input layer mainly comprises the boiling point distribution obtained in accordance with the method of the present invention. The boiling point distribution input to the network may comprise more or less boiling point temperatures as desired with the minimum being the 50 volume % boiling point temperature. The input layer may additionally comprise other parameters to compensate for the presence of additives or property boosters (such as RVP to compensate for the normal-butane and normal- and iso-pentane addition as an octane number enhancer) or SG or inherent structural information (such as the PNA or PIONA or ASO composition) for the purpose of the present invention.

Detailed description of the NN architecture used for the purpose of this invention is explained in details in Albahri [33] the teachings of which are incorporated herein by reference. Those experts in the art can easily ascertain that any network type, network architecture, input range, training function, adaptive learning function, and transfer function may be used without departing from the spirit and scope of the present invention and are all claimed herein.

### EXAMPLE 4

### Prediction of Petroleum Fractions Reid Vapor Pressure Using Neural Networks

The network architecture of Example 3 was used to predict the RVP of petroleum fractions using 20 neurons in the hidden layer and the same seven neurons in the input layer comprising the ASTM D86 boiling point temperatures at several volume % distilled. Seventy percent of the total 362 experimental samples were used to train the neural networks while the remaining thirty percent were used to test the trained network. Model predictions for RVP were in excellent agreement with the experimental data. The overall correlation coefficient was 0.995 for the combined training and testing sets as shown in the parity diagram in FIG. 13. The overall average deviation was 0.3186 psi and the overall maximum deviation was 2.0 psi which is well within the experimental accuracy. The RVP ranged from 0.1 to 66 psi and boiling point ranged from 17 to 500 degrees C.

### EXAMPLE 5

### Measurement of Petroleum Fractions Research Octane Number (RON) Using Neural Networks

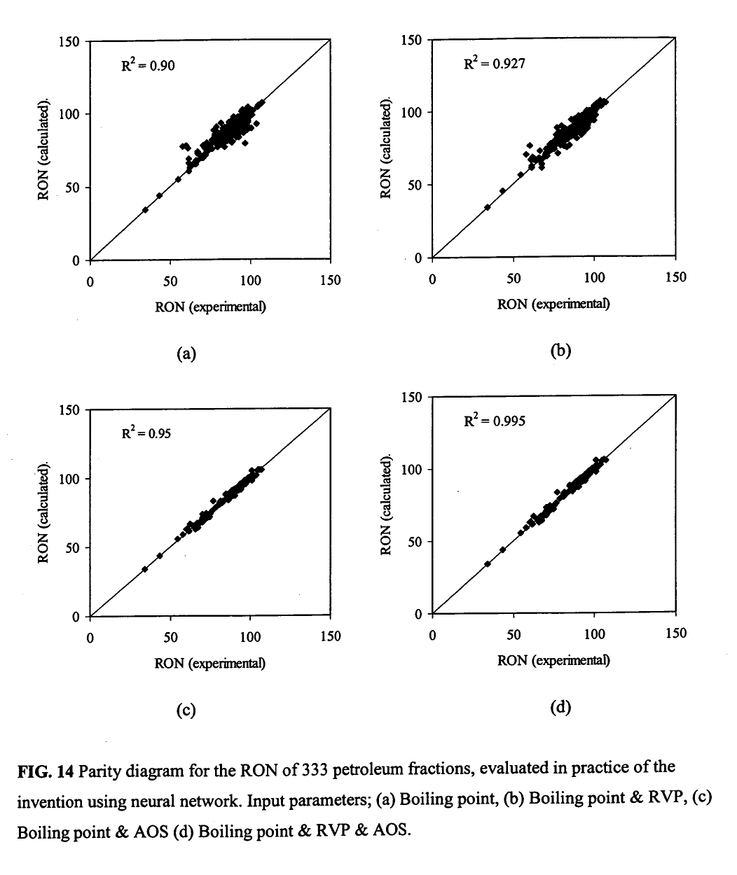

Several neural network architectures were investigated for their ability to predict the research octane number of gasoline. The network architecture of Example 3 was used to predict the RON of gasoline using 18 neurons in the hidden layer and the same input parameters as in that example comprising the ASTM D86 boiling point data alone. Seventy percent of the data was used to train the neural networks while the remaining thirty percent were used to test the trained network. Model predictions for RON were in moderate agreement with experimental data with an overall correlation coefficient was 0.90. For the combined training and testing sets, comprising 333 experimental samples, the overall average deviation was 2.8 and the overall maximum deviation was 31. The RON ranged from 34 to 107 and boiling point ranged from 17 to 500 degrees C. The parity diagram for the model's predictions is shown in FIG. 14(a).

In an effort to improve the models prediction, several other network architectures were investigated for their ability to predict RON using such input parameters as Reid vapor pressure (RVP) and Aromatic, Olefin, and Saturate fractional composition (AOS) in addition to the ASTM D86 boiling point temperatures. A summary of the models predictions is shown in Table 5.

TABLE 5
Neural network architectures for predicting the RON of gasoline.

| | | No. of | | | |
|---|---|---|---|---|---|
| | | neurons in | average | maximum | correlation |
| Input parameters | | hidden layers | % error | % error | coefficient |
| 1. | Boiling point | 18 | 2.8 | 31.2 | 0.90 |
| 2. | Boiling point + | 16 | 2.5 | 26.8 | 0.927 |
| | RVP | | | | |
| 3. | Boiling point + | 7 | 2.2 | 22.7 | 0.95 |
| | AOS | | | | |
| 4. | Boiling point + | 7 | 1.12 | 8.2 | 0.995 |
| | RVP + AOS | | | | |

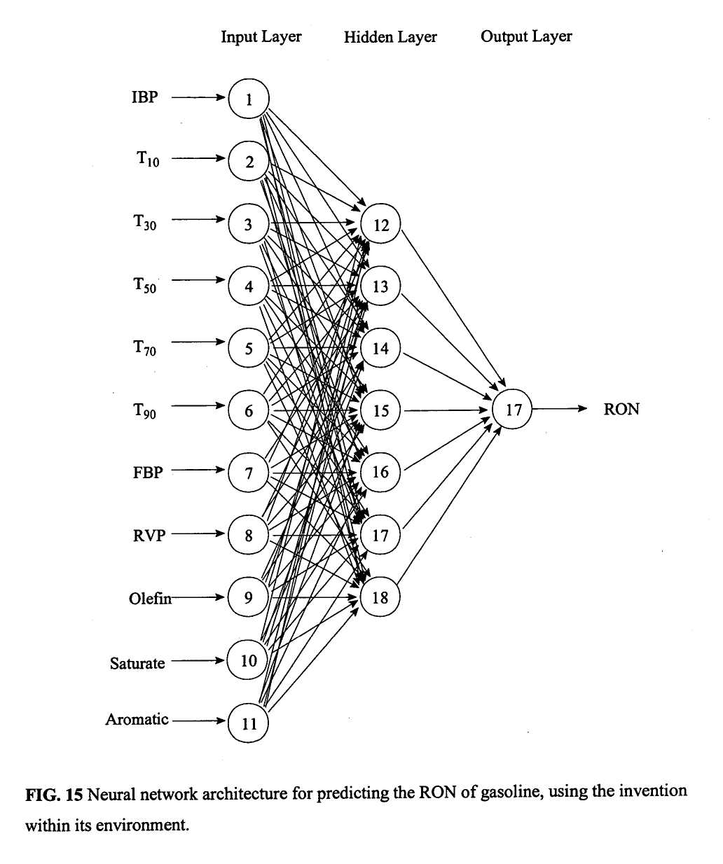

Best results are obtained from the neural network architecture shown in FIG. 15 comprising 7 neurons in the hidden layer and 11 neurons in the input layer comprising the ASTM D86 boiling point temperatures at several volume % distilled in addition to the RVP and the Aromatic, Olefin, and Saturate fractional composition (AOS) with an overall average % error of 1.12 and correlation coefficient of 0.995 which is to our knowledge the best available yet in the whole literature. The parity diagram for all cases is shown in FIG. 14(a) through (d).

In the absence of experimental data the RVP and AOS may be predicted as shown above in Examples 1 and 4 or from generalized correlations available in the literature making the distillation temperatures the only model input required to predict the RON. Similar neural network architecture may further be used to predict motor octane number (MON) as well.

### EQUIVALENTS

From the foregoing description, one skilled in the art can easily ascertain the essential characteristics of this invention and, without departing from the spirit and scope thereof, can make various changes and modifications of the invention to adapt it to various usages and conditions.

Such variations and changes may include, but are not limited to, altering the number of components in the molecular ensemble using mathematical and/or computational methods to arrive at a practical set that can still represent the chemical and physical behavior of the petroleum fraction, developing mixing rules with interaction parameters to predict more properties of petroleum fractions and further improve on existing ones, enhancing the prediction capabilities for the said properties as a function of temperature and pressure. It is believed that such can be accomplished without excessive experimentation. In any case, any such variations are all claimed under the scope of this invention.

Those experts in the art will also realize that method of the invention as explained by exemplary equations and conditions and is not to be construed as limiting but only to provide examples.

The methods of the present invention have been explained with reference to plurality of references the teachings of which are all incorporated herein by reference.

This invention has been described hereinabove, although with reference to a plurality of illustrative exemplary and preferred embodiments, it is to be understood that is in no way to be construed as limiting. However, it is readily appreciated that, from reading this disclosure, the invention may be embodied in other specific forms without departing from the spirit or essential characteristics or attributes to bring modifications by replacing some elements of this invention as practiced by their equivalents, which would achieve the same goal thereof and accordingly reference should be made to the appended claims, rather than to the foregoing specification, as indicating the scope of the invention. Accordingly, those skilled in the art will recognize, or be able to ascertain using no more than routine experimentation, many equivalents to the specific embodiments and the scope of the invention being indicated by the appended claims described herein. Such equivalents, obvious variations, and all changes which come within the meaning and equivalency of the claims are therefore intended to be encompassed therein and are deemed covered by the claims of this invention.

TABLE 2
The molecular ensemble used to characterize petroleum naphtha.

| | |
|---|---|
| 1 | Propane |
| 2 | isobutane |
| 3 | n-butane |
| 4 | 2-methyl butane (isopentane) |
| 5 | n-pentane |
| 6 | Cyclopentane |
| 7 | 2,2-dimethyl butane (neohexane) |
| 8 | 2,3-dimethyl butane |
| 9 | 2-methyl pentane |
| 10 | 3-methyl pentane |
| 11 | N-hexane |
| 12 | methylcyclopentane |
| 13 | 2,2-dimethylpentane |
| 14 | Benzene |
| 15 | 2,4-dimethylpentane |
| 16 | Cyclohexane |
| 17 | 2,2,3-trimethylbutane (Triptane) |
| 18 | 3,3-dimethylpentane |
| 19 | 1,1-dimethyl cyclopentane |
| 20 | 2,3-dimethylpentane |
| 21 | 2-methylhexane |
| 22 | cis-1,3-dimethylcyclopentane |
| 23 | 1,2-dimethyl cyclopentane-trans |
| 24 | 3-methylhexane |
| 25 | trans-1,3-dimethylcyclopentane |
| 26 | 3-ethylpentane |
| 27 | N-heptane |
| 28 | Ethylcyclopentane |
| 29 | 2,2-dimethylhexane |
| 30 | 2,5-dimethylhexane |
| 31 | 2,4-dimethylhexane |
| 32 | 2,2,3-trimethylpentane |
| 33 | Toluene |
| 34 | 3,3-dimethylhexane |
| 35 | 2,3-dimethylhexane |
| 36 | 2-methyl-3-ethylpentane |
| 37 | 2-methylheptane |
| 38 | 3,4-dimethylhexane |
| 39 | 4-methylheptane |
| 40 | 3-methyl-3-ethylpentane |
| 41 | 3-ethylhexane |
| 42 | 3-methylheptane |
| 43 | cis-1,3-ethylmethylcyclopentane |
| 44 | trans-1,2-ethylmethylcyclopentane |
| 45 | trans-1,3-ethylmethylcyclopentane |
| 46 | 2,2,5-trimethylhexane |
| 47 | N-octane |
| 48 | cis-1,2-ethylmethylcyclopentane |
| 49 | 2,3,5-trimethylhexane |
| 50 | 2,2-dimethylheptane |
| 51 | 2,4-dimethylheptane |
| 52 | 2-methyl-4-ethylhexane |
| 53 | 2,6-dimethylheptane |
| 54 | 2,5-dimethylheptane |
| 55 | 3,5-dimethylheptane |
| 56 | Ethylbenzene |
| 57 | 3,3-dimethylheptane |
| 58 | P-xylene |
| 59 | M-xylene |
| 60 | 2,3-dimethylheptane |
| 61 | 3,4-dimethylheptane |
| 62 | 4-ethylheptane |
| 63 | 4-methyloctane |
| 64 | 3-ethylheptane |
| 65 | 2-methyloctane |
| 66 | o-xylene |
| 67 | 3-methyloctane |
| 68 | n-nonane |

TABLE 3
Comparison of global properties of light reformate
calculated from generalized correlations and from
aggregation of pure components using MEPP model.

| | Experimental | | |
|---|---|---|---|
| | or predicted | MECM | |
| | from | simulation | % error |
| Property | experimental | Note (1) | (Deviation) |
| Specific Gravity. | 0.7143 | 0.7083 | −0.84 |
| Vapor Pressure @ | 0.7033 | 0.7033 | 0 |
| 37.8° C., bar. | | | |
| Reid vapor pressure, bar. | 0.655 | 0.655 | 0 |
| Cubic average boiling | 87.7 | 82.6 | −1.44 |
| point, ° C.. | | | |
| Mean average boiling | 84.4 | 81.1 | −0.94 |
| point, ° C.. | | | |
| Volume average boiling | 89.3 | 84.1 | −1.45 |
| point, ° C.. | | | |
| Weight average boiling | 90.3 | 87.1 | −0.92 |
| point, ° C.. | | | |
| Mole average boiling | 81.6 | 79.6 | −0.57 |
| point, ° C.. | | | |
| Watson characterization | 12.09 | 12.18 | 0.77 |
| factor. | | | |
| Molecular weight, gm/mole. | 93.5 | 93.1 | −0.42 |
| Refractive index. | 1.3973 | 1.396 | −0.09 |
| Hydrogen content, wt frac. | 0.1458 | 0.1507 | 3.34 |
| Kinematic Viscosity @ | 0.32 | 0.31 | −3.56 |
| 98.9° C., mm2/sec. | | | |
| Kinematic Viscosity @ | 0.48 | 0.49 | 1.7 |
| 37.8° C., mm2/sec. | | | |
| Surface tension @ 25° C., | 20.44 | 19.48 | −4.7 |
| dynes/cm. | | | |
| Aniline Point, ° C.. | 37.8 | 57.1 | 6.21 |
| Critical Temperature, ° C.. | 265.6 | 261.3 | −1.51 |
| Pseudo Critical | 254.4 | 254.8 | 0.14 |
| Temperature, ° C.. | | | |
| Pseudo Critical | 31.03 | 31.23 | 0.67 |
| Pressure, psia. | | | |
| Critical compressibility | 0.2773 | 0.2664 | −3.91 |
| factor. | | | |
| Paraffins content, mole %. | 71.5 | 70.88 | −0.87 |
| Naphthenes content, mole %. | 17.19 | 17.43 | 1.43 |
| Aromatics content, mole %. | 11.3 | 11.7 | 3.34 |
| Acentric factor. | 0.284 | 0.285 | 0.32 |
| Freezing Point, ° C.. | −102.3 | −104.7 | −1.44 |
| Research octane number | 72.3 | 73.2 | 1.23 |
| Motor octane number | 70 | 71.7 | 2.37 |
| Heat of vaporization @ | 322.08 | 323.06 | 0.31 |
| NBP(note 2), J(abs)/gm. | | | |
| Net Heat of combustion @ | 44,245 | 44,047 | −0.11 |
| 25° C., J(abs)/gm. | | | |
| Isobaric liquid heat capacity | 2.437 | 2.039 | −16.38 |
| @ 15.6° C., J(abs)/gm. K. | | | |
| Isobaric vapor heat capacity | 1.882 | 1.604 | −14.79 |
| @ 15.6° C., J(abs)/gm. K. | | | |
| Liquid thermal | 0.1099 | 0.1161 | −9.08 |
| conductivity @ 25° C., | | | |
| J(abs)/sec-m²-K/m. | | | |

Notes:
(1) from aggregation of pure components,
(2) at 0 psig and MeABP.

TABLE 4
Error analysis for some of the properties investigated.

| | | Value | Av. % | Correlation |
|---|---|---|---|---|
| No. | Property | Range | error | Coefficient |
| 1 | API gravity | 35-94 | 2.14 | 0.99 |
| 2 | Cubic average boiling | 34-134 | 1.34 | 0.995 |
| | point, ° C. | | | |
| 3 | Mean average boiling | 32-133 | 0.99 | 0.995 |
| | point, ° C. | | | |
| 4 | Volume average boiling | 35-134 | 1.34 | 0.995 |
| | point, ° C. | | | |
| 5 | Molar average boiling | 30-134 | 0.83 | 0.995 |
| | point, ° C. | | | |
| 6 | Weight average boiling | 35-134 | 1.07 | 0.996 |
| | point, ° C. | | | |
| 7 | Watson characterization | 10.61-13.06 | 0.8 | 0.97 |
| | factor | | | |
| 8 | Molecular weight, | 68.2-110.8 | 2.06 | 0.99 |
| | gm/mole | | | |
| 9 | Refractive index | 1.3546-1.4764 | 0.21 | 0.993 |
| 10 | Hydrogen content, | 0.1063-0.1716 | 2.57 | 0.965 |
| | wt fraction | | | |
| 11 | Motor octane number | 60-97 | 4.15 | 0.85 |
| 12 | Kinematic viscosity at | 0.25-0.43 | 4.04 | 0.96 |
| | 98.9° C., mm2/sec | | | |
| 13 | Kinematic viscosity at | 0.32-0.7 | 5.41 | 0.972 |
| | 37.8° C., mm2/sec | | | |
| 14 | Surface Tension of | 14.51-27.96 | 2.67 | 0.995 |
| | liquid at 25° C., | | | |
| | dynes/cm | | | |
| 15 | Aniline Point, ° C. | 20-65 | 1.74 | 0.83 |
| 16 | True critical | 196-338 | 0.93 | 0.991 |
| | temperature, ° C. | | | |
| 17 | Pseudocritical | 191-338 | 0.8 | 0.989 |
| | temperature, ° C. | | | |
| 18 | Pseudocritical | 26.2-35.9 | 2.22 | 0.9 |
| | pressure, bar | | | |
| 19 | Heat of vaporization | 311.6-363.7 | 1.17 | 0.948 |
| | at NBP, J(abs)/gm | | | |
| 20 | Net heat of combustion | 43,996-45,362 | 0.18 | 0.96 |
| | at 25° C., J(abs)/gm | | | |
| 21 | Freezing, ° C. | (−119)-(−72) | 5.38 | — |
| 22 | Acentric factor | 0.244-0.312 | 3.13 | 0.946 |
| 23 | Critical | 0.2750-0.2805 | 0.25 | 0.832 |
| | compressibility | | | |
| | factor | | | |
| 24 | Flash point, ° C. | (−74)-(23) | 5.16 | 0.924 |
| 25 | Liquid thermal | 0.1020-0.1211 | 1.78 | 0.976 |
| | conductivity at | | | |
| | 25° C., J(abs)/ | | | |
| | sec-m²-K/m | | | |

References
(1) American Petroleum Institute, API Technical Data Book—Petroleum Refining; Daubert, Danner, Eds.; API, Washington, D.C., 1989.
(2) Albahri, T. A. Ind. Eng. Chem. Res. Under Review, 2005.
(3) Albahri, T. A. Simulation of Light Petroleum Fractions. ACS Symposium Series; American Chemical Society, Division of fuel chemistry preprints: Anaheim, Calif., 2004; Vol. 49(1), pp. 327-328.
(4) Albahri, T. A. Enhanced Method for Predicting the Properties of Petroleum Fractions. ACS Symposium Series; American Chemical Society, Division of fuel chemistry preprints: Philadelphia, Pa., 2004 (22-26 August); Vol. 49(2), pp. 925-926.
(5) American Institute of Chemical Engineers, DIPPR Project 801, Pure Component Data in DIPPRO, public electronic version; NY, N.Y., 1996.
(6) Reid, R. C.; Prausnitz, J. M.; Polling B. E. The properties of gases and liquids; McGraw-Hill: New York, 1987.
(7) Richardson, M. L.; Gangolli, S. The dictionary ofsubstances and their effects; Royal Society of Chemistry, Cambridge, 1993.
(8) Albahri, T. A. Ind. Eng. Chem. Res. 2003, 42, 657-662.
(9) Albahri, T. A.; Zayed, F. I. ACS Symposium Series; American Chemical Society, Division of fuel chemistry preprints: NY, N.Y., 2003; Vol. 48(4), pp. 258-260.
(10) Albahri, T. A. Structure Property Relation for the Heat of combustion of Pure Liquid Hydrocarbons. Kuwait University, unpublished results.
(11) Albahri, T. A. Chemical Engineering Science. 2003, 58, 3629-3641.
(12) Albahri, T. A. Mechanistic Modeling of Catalytic Cracking Chemistry. PhD Dissertation, University of Texas at Austin, Tex., 1999.
(13) Neurock, M.; Nigam, A.; Trauth, D.; Klein, M. T. Chemical Engineering Science. 1994, 49, 4153-4177.
(14) Ramadhan, 0. M.; Al-Hyali, E. A. S. Petroleum Science and Technology. 1999, 17, 623.
(15) Wauquier, J. -P., “Petroleum Refining Vol. 1; Editions Technip: Paris, 1995.
(16) Li, C. C. Can. J Chem. Eng. 1970, 19, 709.
(17) Riazi, M. R. Ind. Eng. Chem. Res. 1989, 28, 1731-1735.
(18) EPCON international; The American Petroleum Institute. API Technical Database on petroleum refining (electronic version), V2. 1.1; EPCON international: Woodsfield, Ohio, 2000.
(19) Riazi M. R., Daubert T. E. Ind. Eng. Chem. Proc. Des. Dev. 1980, 19, 289-297.
(20) Riazi, M. R.; Albahri, T. A.; Alqattan, A. H. Petroleum Science and Technology. 2005, 23, 75-86.
(21) Jabr N., Alatiqi I. M., Fahim M. A. Can. J Chem. Eng. 1992, 70, 765-773.
(22) Frontline Systems, Inc. Premium Solver Platform V6. 0; Frontline Systems, Incline Village, Nev., 2004.
(23) Healy, W. C.; Maassen, C. W.; Peterson, R. T. American Petroleum Institute's Division of Refining, 1959, 39, 132-192.
(24) Riazi M. R.; Daubert T. E. Ind. Eng. Chem. Proc. Des. Dev. 1986, 25, 1009-1015.
(25) Riazi M. R. Ind. Eng. Chem. Res. 1997, 36, 4299-4307.
(26) Lee, B. I.; Kessler, M. G. AIChEJ. 1975, 21, 510.
(27) Astron International Inc. Petrochem Toolkit V1.5; Gulf Publishing: Houston, Tex., 1997.
(28) Albahri, T. A. Consistent Method for Correlating Experimental Data. Kuwait University, unpublished results.
(29) Aboul-Seoud, A.; Moharam, H. M. Trans. IChemE, 1999, 77, 248-252.
(30) Nelson, W.L. Oil & Gas Journal, 1969, 67, 122.
(31) Jenkins, G. I.; Walsh, R. P. Hydrocarbon Processing, 1968, 47, 161-164.
(32) Gorenkov, A. F.; Lifanova, T. A.; Klyuiko, I. G.; Kupreev, A. I. Chemistry and Technology of Fuels and Oils, 1984, 20, 262-264.
(33) Tareq A. Albahri, Reena S. George, Ind. & Eng. Chem. Res. 2003, Vol. 42, No. 22, pp. 5708-5714.

What I claim as my invention is:

1. A method for measuring the chemical, performance, perceptual or physical properties of a hydrocarbon sample which comprises, but not limited to, at least one of the following properties:
the molecular weight,
the true vapor pressure,
the specific (API) gravity,
the cubic average boiling point (CABP),
the mean average boiling point (MeABP),
the volumetric average boiling point (VABP),
the weight average boiling point (WABP),
the molar average boiling point (MABP),
the Watson characterization factor (Kw),
the refractive index,
the carbon to hydrogen content,
the kinematic viscosity,
the surface tension of liquid,
the aniline point, the cloud point,
the true critical temperature,
the pseudocritical temperature,
the true critical pressure,
the pseudocritical pressure,
the critical compressibility factor,
the acentric factor,
the flash point,
the freezing point,
the heat of vaporization at the normal boiling point,
the net heat of combustion,
the isobaric liquid heat capacity,
the isobaric vapor heat capacity,
the liquid thermal conductivity,
the research octane number, and
the motor octane numbers; which comprises:
a) placing said hydrocarbon sample in a distillation apparatus; analyzing a of said sample by distillation, under suitable and repeatable conditions, to determine the boiling point distribution of the components of said hydrocarbon in distillation apparatus;
b) determining the hydrocarbon-group fractional composition and vapor pressure of the petroleum sample by calculation from the first set of data of step (a) or by analyzing the petroleum sample by a suitable method, under suitable and repeatable conditions;
c) applying at least the first set of data of step (a) or in combination with the second set of data of step (b) to determine the molecular distribution of a molecular ensemble comprising a pre-selected set of true-components or pseudocomponents;
d) inputting the values of at least the first set of data of step (a), the second set of data of step (b), or the third set of data of step (c) into a computational model;
e) applying a computational method to said sets of data of step (d) comprising a mathematical model wherein the computation method further performs a correlation between the amounts of the detected values of said sets of data to the properties of the fuel; and
g) determining the physical and chemical property that is derived from the hydrocarbon as a function of at least the boiling point distribution of its components in-situ or in real time.

2. The method of claim 1, wherein the computational method in step (e) comprises at least one of the following methods; optimization, neural networks, multivariate regression, partial least square regression, principal component regression, a topological approach, genetic algorithms, or any computational method that is currently known or will be known in the future;

3. The method of claim 1, wherein the boiling point distribution is used to determine the composition of a molecular ensemble comprising a pre-selected set of pure components.

4. The method of claim 1 wherein the selection of the series of molecular compounds or compound classes comprising the molecular ensemble is accomplished by using at least one or a combination of; boiling point distribution, hydrocarbon type analysis, vapor pressure, and Chemist's Rules.

5. The method of claim 1, wherein the distillation apparatus conforms to at least one of the following standard or otherwise non-standard test methods and its apparatus;
(a) ASTM D86-96 (atmospheric distillation of light petroleum fractions);
(b) IP-4 distillation;
(c) micro distillation;
(d) molecular distillation;
(e) fractional distillation ( Spinning Band Still);
(f) ASTM D5236 distillation (Pot Still);
(g) ASTM D160 (Vacuum distillation of heavy petroleum fractions);
(h) ASTM D2887 also known as GC SimDist (TBP Simulated Distillation; GC method);
(i) ASTM D3710 (TBP Simulated Distillation; GC method);
(j) ASTM D2892 (15/5 distillation; 15 theoretical plate column; simulated TBP);
(k) ASTM D5236 (Vacuum Pot-still Method for heavy petroleum fractions);
(l) ASTM D5307 (Simulated Distillation; GC method); TBP of crude oil);
(m) ASTM D6352-98 (Simulated Distillation; GC method; Replaces ASTM D2887);
(n) combination of tests (a) and (f) for wide boiling range materials;
(o) Hemple distillation; or
(p) any standard or otherwise nonstandard distillation that is known now or will be known in the future

6. The method of claim 1, wherein the boiling point distribution in is obtained from at least one of the following standard or otherwise non standard test methods and procedures;
(a) ASTM D86-96 (atmospheric distillation of light petroleum fractions);
(b) IP-4 distillation;
(c) micro distillation,
(d) molecular distillation;
(e) fractional distillation ( Spinning Band Still);
(f) ASTM D5236 distillation (Pot Still);
(g) ASTM D1160 (Vacuum distillation of heavy petroleum fractions);
(h) ASTM D2887 also known as GC SimDist (TBP Simulated Distillation; GC method);
(i) ASTM D3710 (TBP Simulated Distillation; GC method);
(j) ASTM D2892 ( 15/5 distillation; 15 theoretical plate column; simulated TBP);
(k) ASTM D5236 (Vacuum Pot-still Method for heavy petroleum fractions);
(l) ASTM D5307 (Simulated Distillation; GC method); TBP of crude oil);
(m)ASTM D6352-98 (Simulated Distillation; GC method; Replaces ASTM D2887);
(n) combination of tests (a) and (f) for wide boiling range materials;
(o) Hemple distillation; and
(p) any standard or otherwise nonstandard distillation that is known now or will be known in the future

7. The method of claim 1, wherein said hydrocarbon is a petroleum fraction has a boiling point less than 250 degree C such as a light petroleum fraction such as light petroleum naphtha or gasoline.

8. The method of claim 1 wherein said data from steps (a) to (c) are stored in a standalone computer or in an integrated computer in the distillation apparatus.

9. The method of claim 1 wherein said data from steps (a) to (c) are treated in a standalone computer or in an integrated computer in the distillation apparatus.

10. The method of claim 1 wherein computations in steps (d) to (g) are performed in a standalone computer or in an integrated computer in the distillation apparatus.

11. The method according to claim 1 wherein said method for predicting the fluid properties:
(a) is powerful for simulating and predicting the properties of petroleum fuels;
(b) is simple and straightforward;
(c) requires limited information from readily available lab analysis and simple analytical characterizations to describe the petroleum feedstock;
(d) can predict the global properties of molecular ensembles produced during various physical and chemical processing scenarios as they progresses;
(e) can be combined with or incorporated in process simulation packages thus enhancing their information content;
(f) provides a foundation for developing molecular-based property relationships and incorporating well-established correlations to estimate mixture properties, which is an essential need of future process models; the capability of predicting physical and performance properties of undefined multicomponent hydrocarbon mixtures during processing;
(g) has the ability to complement the molecularly-explicit kinetic models of petroleum refining processing making use of the vast information available in the literature on pure components.
(h) has flexibility where the number and type of model components in the molecular ensemble may be tailored as needed by the user to accommodate a specific simulation need;
(i) can be incorporated as software in the distillation apparatus hardware to provide estimation of more than 30 properties of petroleum fractions using one single laboratory test;
(j) leads to large savings in terms of energy, time and cost;
(k) can predict the properties of undefined multicomponent mixtures and light petroleum fractions like naphtha and gasoline using a characterization method that is more suitable for incorporation in the molecularly-explicit simulation models than the current methods and can enhance the prediction performance of chemical process simulation packages;
(l) combines routine analytical tests and a molecularly-explicit modeling approach to provide quantitative insight to the petroleum fractions structure permitting easy accounting of molecules and enabling the direct estimation of the thermodynamic and transport properties thereof;
(m) can calculate the properties of light petroleum fractions with good accuracy when at least one bulk property is available (e.i. ASTM D86, TBP distillation temperatures, or any boiling point distribution);
(n) is applicable to any petroleum fraction;
(o) can model complex nature of petroleum fuels by a limited set of representative true or pseudocomponents considering the difficulty and complexity of accounting for the thousands of compounds in petroleum fuels;
(p) is a useful tool in representing a broad range of different petroleum feedstocks provided relatively simple set of experiments are performed to characterize the attributes of the feed;
(q) provide direct input for molecular reaction models that require feedstock structure and properties which can ultimately be used to map out the changing molecular population with respect to various processing conditions;
(r) can be of benefit for the future modeling of the various aspects of petroleum refinery processes which require detailed knowledge of both the molecular composition and structure of the petroleum fraction feeds, intermediates and products for the proper modeling of the physical separations and chemical reactions of refinery units;
(s) can be used for the simulation of gasoline production processes such as Catalytic Reforming, Alkylation, Isomerization, and (Fischer-Tropsch) gasoline synthesis as well as the blending of the feeds and products of these processes for gasoline production, to increase octane number, improve efficiency, and reduce cost and pollution; and
(t) can predict the properties of petroleum fuels from distillation data alone, since except for the boiling point distribution the availability of other properties is not essential and can be estimated using the model.

12. An apparatus for measuring the chemical, performance, perceptual or physical properties of a hydrocarbon sample which comprises, but not limited to, at least one of the following properties:
the molecular weight,
the true vapor pressure,
the specific (API) gravity,
the cubic average boiling point (CABP),
the mean average boiling point (MeABP),
the volumetric average boiling point (VABP),
the weight average boiling point (WABP),
the molar average boiling point (MABP),
the Watson characterization factor (K_{w}),
the refractive index,
the carbon to hydrogen content,
the kinematic viscosity,
the surface tension of liquid,
the aniline point, the cloud point,
the true critical temperature,
the pseudocritical temperature,
the true critical pressure,
the pseudocritical pressure,
the critical compressibility factor,
the acentric factor,
the flash point,
the freezing point,
the heat of vaporization at the normal boiling point,
the net heat of combustion,
the isobaric liquid heat capacity,
the isobaric vapor heat capacity,
the liquid thermal conductivity,
the research octane number, and
the motor octane numbers; which comprises:
a) placing said hydrocarbon sample in said distillation apparatus; analyzing a of said sample by distillation, under suitable and repeatable conditions, to determine the boiling point distribution of the components of said hydrocarbon in distillation apparatus;
b) determining the hydrocarbon-group fractional composition and vapor pressure of the petroleum sample by calculation from the first set of data of step (a) or by analyzing the petroleum sample by a suitable method, under suitable and repeatable conditions;
c) applying at least the first set of data of step (a) or in combination with the second set of data of step (b) to determine the molecular distribution of a molecular ensemble comprising a pre-selected set of true-components or pseudocomponents;
d) inputting the values of at least the first set of data of step (a), the second set of data of step (b), or the third set of data of step (c) into a computational model;
e) applying a computational method to said sets of data of step (d) comprising a mathematical model wherein the computation method further performs a correlation between the amounts of the detected values of said sets of data to the properties of the fuel; and
g) determining the physical and chemical property that is derived from the hydrocarbon as a function of at least the boiling point distribution of its components in-situ or in real time.

13. The apparatus of claim 12, wherein the computational method in step (e) comprises at least one of the following methods; optimization, neural networks, multivariate regression, partial least square regression, principal component regression, a topological approach, genetic algorithms, or any computational method that is currently known or will be known in the future;

14. The apparatus of claim 12 wherein the selection of the series of molecular compounds or compound classes comprising the molecular ensemble is accomplished by using at least one or a combination of; boiling point distribution, hydrocarbon type analysis, vapor pressure, and Chemist's Rules.

15. The apparatus of claim 12, wherein said distillation apparatus conforms to at least one of the following standard or otherwise non-standard test methods and its apparatus;
(a) ASTM D86-96 (atmospheric distillation of light petroleum fractions);
(b) IP-4 distillation;
(c) micro distillation;
(d) molecular distillation;
(e) fractional distillation ( Spinning Band Still);
(f) ASTM D5236 distillation (Pot Still);
(g) ASTM D1160 (Vacuum distillation of heavy petroleum fractions);
(h) ASTM D2887 also known as GC SimDist (TBP Simulated Distillation; GC method);
(i) ASTM D3710 (TBP Simulated Distillation; GC method);
(j) ASTM D2892 ( 15/5 distillation; 15 theoretical plate column; simulated TBP);
(k) ASTM D5236 (Vacuum Pot-still Method for heavy petroleum fractions);
(l) ASTM D5307 (Simulated Distillation; GC method); TBP of crude oil);
(m) ASTM D6352-98 (Simulated Distillation; GC method; Replaces ASTM D2887);
(n) combination of tests (a) and (f) for wide boiling range materials;
(o) Hemple distillation; or
(p) any standard or otherwise nonstandard distillation that is known now or will be known in the future

16. The apparatus of claim 12 wherein said data from steps (a) to (c) are stored in a standalone computer or in an integrated computer in said distillation apparatus.

17. The apparatus of claim 12 wherein said data from steps (a) to (c) are treated in a standalone computer or in an integrated computer in said distillation apparatus.

18. The apparatus of claim 12 wherein computations in steps (d) to (g) are performed in a standalone computer or in an integrated computer in said distillation apparatus.

19. The apparatus of claim 12 comprising a microprocessor to execute the correlation means and a display screen to display said predicted properties.

20. The apparatus according to claim 12 wherein said apparatus for predicting the fluid properties:
(a) is simple and straightforward;
(b) can predict more than 30 global properties of petroleum hydrocarbons using one single laboratory test;
(c) leads to large savings in terms of energy, time and cost; (d) can predict the properties of undefined multicomponent mixtures and light petroleum fractions like naphtha and gasoline using a characterization method that is more suitable for incorporation in the molecularly-explicit simulation models than the current methods and can enhance the prediction performance of chemical process simulation packages;
(e) combines routine analytical tests and a molecularly-explicit modeling approach to provide quantitative insight to the petroleum fractions structure permitting easy accounting of molecules and enabling the direct estimation of the thermodynamic and transport properties thereof;
(f) is applicable to any petroleum fraction;
(g) can model complex nature of petroleum fuels by a limited set of representative true or pseudocomponents considering the difficulty and complexity of accounting for the thousands of compounds in petroleum fuels;
(h) provide direct input for molecular reaction models that require feedstock structure and properties which can ultimately be used to map out the changing molecular population with respect to various processing conditions;
(i) can be of benefit for the future modeling of the various aspects of petroleum refinery processes which require detailed knowledge of both the molecular composition and structure of the petroleum fraction feeds, intermediates and products for the proper modeling of the physical separations and chemical reactions of refinery units;
(j) can be used for the simulation of gasoline production processes such as Catalytic Reforming, Alkylation, Isomerization, and (Fischer-Tropsch) gasoline synthesis as well as the blending of the feeds and products of these processes for gasoline production, to increase octane number, improve efficiency, and reduce cost and pollution; and
(k) can predict the properties of petroleum fuels from distillation data alone, since except for the boiling point distribution the availability of other properties is not essential and can be estimated using the model.
